(19) United States
(12) Patent Application Publication
(10) Pub. No.: US 2003/0041076 A1
(43) Pub. Date: Feb. 27, 2003

(54) Schema-based services for identity-based access to calendar data

(76) Inventors: Mark H. Lucovsky, Sammamish, WA (US); Paul Andrew Steckler, Redmond, WA (US); Walter C. Hsueh, San Jose, CA (US); Kendall D. Keil, Bothell, WA (US); Burra Gopal, Redmond, WA (US)

Correspondence Address: MICHALIK & WYLIE PLLC, Suite 103, 14645 Bel-Red Road, Bellevue, WA, 98007, US

(21) Appl. No.: 10/021,264

(22) Filed: Oct. 22, 2001

Related U.S. Application Data
(60) Provisional application No. 60/275,809, filed on Mar. 14, 2001.

(51) Int. Cl. G06F 17/00

(52) U.S. Cl. 707/500

(57) ABSTRACT

A schema-based calendar service for Internet access to per-user contact data, wherein access to data is based on each user's identity. The calendar service includes a schema that defines rules and a structure for each user's data, and also includes methods that provide access to the data in a defined way. The calendar schema thus corresponds to a logical document containing the data for each user. The user manipulates (e.g., reads or writes) data in the logical document by data access requests through defined methods. In one implementation, the calendar schemas are arranged as XML documents, and the services provide methods that control access to the data based on the requesting user's identification, defined role and scope for that role. In this way, data can be accessed by its owner, and shared to an extent determined by the owner. The structure of the data is defined from the perspective of the data, not from that of an application program or a device, whereby appropriate programs can communicate with the calendar service to access the data, with existing knowledge of the schema-defined format, regardless of the device or application program in use. Extensibility is defined into the schema.

### CROSS REFERENCE TO RELATED APPLICATIONS

The present application claims priority from co-pending U.S. provisional application serial No. 60/275,809, filed Mar. 14, 2001 and entitled “Identity-Based Service Communication Using XML Messaging Interfaces”, which is hereby incorporated herein by reference in its entirety. The present application is related to U.S. patent application Ser. No. ______ entitled Schema-Based Services for Identity-Based Data Access, filed concurrently herewith on Oct. 22, 2001.

### COPYRIGHT DISCLAIMER

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The invention relates generally to computer network data access, and more particularly to systems, methods and data structures for accessing data and data-related services over a network.

### BACKGROUND OF THE INVENTION

There are many types of data that users need to manage and otherwise access. For example, users keep word processing documents, spreadsheet documents, calendars, telephone numbers and addresses, e-mail messages, financial information and so on. In general, users maintain this information on various personal computers, hand-held computers, pocket-sized computers, personal digital assistants, mobile phones and other electronic devices. In most cases, a user's data on one device is not accessible to another device, without some manual synchronization process or the like to exchange the data, which is cumbersome. Moreover, some devices do not readily allow for synchronization. For example, if a user leaves his cell phone at work, he has no way to get his stored phone numbers off the cell phone when at home, even if the user has a computing device or similar cell phone at his disposal. As is evident, these drawbacks result from the separate devices each containing their own data.

Corporate networks and the like can provide users with remote access to some of their data, but many users do not have access to such a network. For many of those that have access, connecting to a network with the many different types of devices, assuming such devices can even connect to a network, can be a complex or overwhelming problem.

Moreover, even if a user has centrally stored data, the user needs the correct type of device running the appropriate application program to access that data. For example, a user with a PDA that maintains a user's schedule (e.g., appointments, meetings and so on) with a simple to-do list application program ordinarily will not be able to use that program to open a calendar stored by an email application program or the like at work. In general, this is because the data is formatted and accessed according to the way the application program wants it to be formatted.

What is needed is a model wherein data is centrally stored for users, with a set of services that control access to the data with defined methods, regardless of the application program and/or device.

### SUMMARY OF THE INVENTION

Briefly, the present invention provides a Calendar service for central (e.g., Internet) access to per-user contact data, based on each user's identity, wherein the calendar service includes a schema that defines rules and a structure for the data, and also includes methods that provide access to the data in a defined way. Because the structure of the data is defined from the perspective of the data, not from that of an application program or a device, programs can communicate with the services to access the data, with existing knowledge of the format. In one implementation, the Calendar schemas are arranged as XML documents, and the services provide methods that control access to the data based on the requesting user's identification, defined role and scope for that role. In this way, data can be accessed by its owner, and shared to an extent determined by the owner. Extensibility is defined into the schema.

Other benefits and advantages will become apparent from the following detailed description when taken in conjunction with the drawings, in which:

### BRIEF DESCRIPTION OF THE DRAWINGS

FIG. 1 is a block diagram representing an exemplary computer system into which the present invention may be incorporated;

FIG. 2 is a block diagram representing a generic data access model in accordance with one aspect of the present invention;

FIG. 3 is a representation of services for identity-based data access in accordance with one aspect of the present invention; and

FIG. 4 is a block diagram representing a schema-based service for accessing data arranged in a logical content document based on a defined schema for that service in accordance with one aspect of the present invention.

### DETAILED DESCRIPTION EXEMPLARY OPERATING ENVIRONMENT

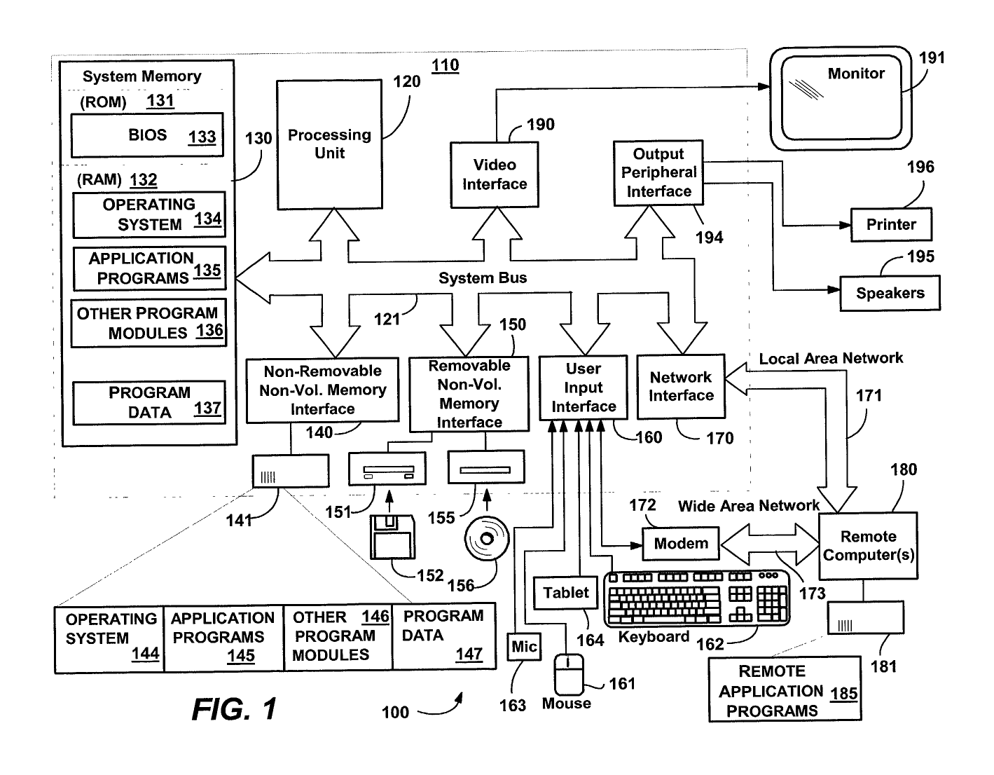

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer system 110 may comprise source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Data Access Model

The present invention generally operates in an architecture/platform that connects network-based (e.g., Internet-based) applications, devices and services, and transforms them into a user's personal network which works on the user's behalf, and with permissions granted by the user. To this end, the present invention is generally directed to schema-based services that maintain user, group, corporate or other entity data in a commonly accessible virtual location, such as the Internet. The present invention is intended to scale to millions of users, and be stored reliably, and thus it is likely that a user's data will be distributed among and/or replicated to numerous storage devices, such as controlled via a server federation. As such, while the present invention will be generally described with respect to an identity-centric model that enables a user with an appropriate identity and credentials to access data by communicating with various core or other services, it is understood that the schema-based services described herein are arranged for handling the data of millions of users, sorted on a per-user-identity basis. Note that while “user” is generally employed herein for simplicity, as used herein the term “user” is really a substitute for any identity, which may be a user, a group, another entity, an event, a project, and so on.

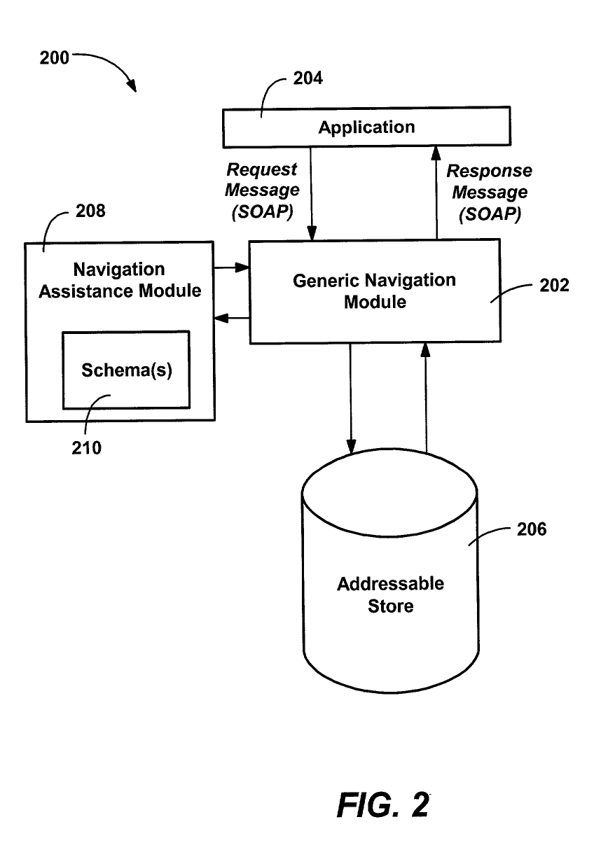

As generally represented in FIG. 2, a data access model 200 includes a generic navigation module 202 through which applications 204 and the like may access a wide variety of identity-based data, such as maintained in an addressable store 206. To access the data, a common set of command methods may be used to perform operations on various data structures that are constructed from the data in the addressable store 206, even though each of those data structures may represent different data and be organized quite differently. Such command methods may describe generic operations that may be desired on a wide variety of data structures, and include, for example, insert, delete, replace, update, query or changequery methods.

In accordance with one aspect of the present invention and as described in detail below, the data is accessed according to various schemas, with the schemas corresponding to identity-based services through which users access their data. As used herein, a “schema” generally comprises a set of rules that define how a data structure may be organized, e.g., what elements are supported, in what order they appear, how many times they appear, and so on. In addition, a schema may define, via color-coding or other identification mechanisms, what portions of an XML document (that corresponds to the data structure) may be operated on. Examples of such XML-based documents are described below. The schema may also define how the structure of the XML document may be extended to include elements not expressly mentioned in the schema.

As will be understood below, the schemas vary depending on the type of data they are intended to organize, e.g., an email-inbox-related schema organizes data differently from a schema that organizes a user's favorite websites. Further, the services that employ schemas may vary. As such, the generic navigation module 202 has associated therewith a navigation assistance module 208 that includes or is otherwise associated with one or more schemas 210. As will be understood, a navigation assistance module 208 as represented in FIG. 2 corresponds to one or more services, and possesses the information that defines how to navigate through the various data structures, and may also indicate which command methods may be executed on what portions of the data structure. Although in FIG. 2 only one navigation assistance module 208 is shown coupled to the generic navigation module 202, there may be multiple navigation assistance modules that may each specialize as desired. For example, each navigation assistance module may correspond to one service. Moreover, although the navigation assistance module 208 is illustrated as a separate module, some or all of the operations of the navigation assistance module 208 may be incorporated into the generic navigation module 202, and vice versa. In one embodiment, the various data structures constructed from the schema and addressable store data may comprise XML documents of various XML classes. In that case, the navigation assistance module 208 may contain a schema associated with each of the classes of XML documents.

The present invention provides a number of schema-based services that facilitate data access based on the identity of a user. Preferably, the user need not obtain a separate identity for each service, but rather obtains a single identity via a single set of credentials, such as with the Microsoft® Passport online service. With such an identity, a user can access data via these services from virtually any network connectable device capable of running an application that can call the methods of a service.

Services and Schemas

“.NET My Services” comprises identity-centric services which may be generally implemented in XML (eXtensible Markup Language) Message Interfaces (XMIs). While the present invention will be described with respect to XML and XMI, it can readily be appreciated that the present invention is not limited to any particular language or set of interfaces. The .NET My Services model essentially corresponds to one implementation of the generic data access model 200 of FIG. 2.

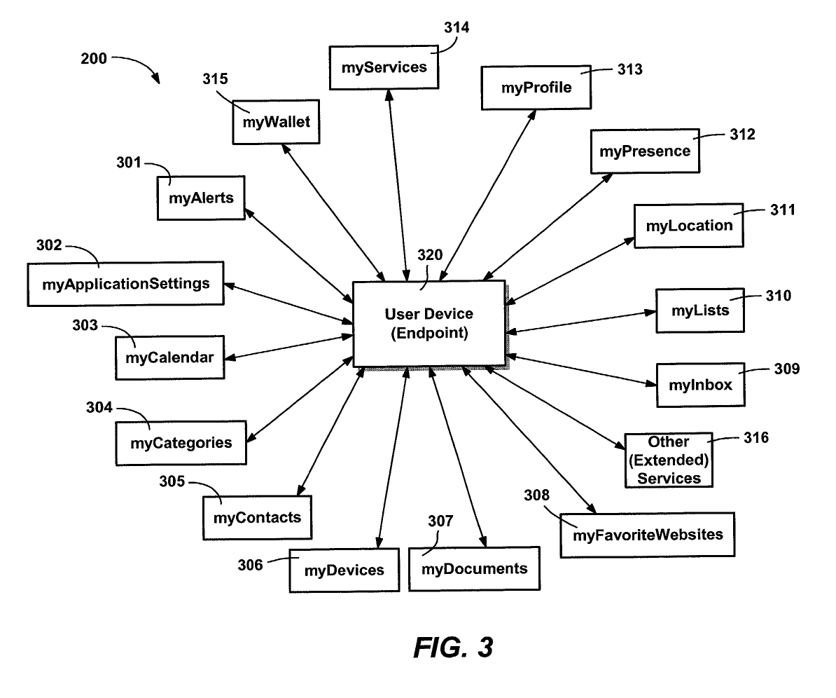

As generally represented in FIG. 3, .NET My Services 300 is implemented as a set of Web services 301-316, each bound to a .NET Identity (PUID, such as a Passports unique identifier similar to a globally unique indentifier when Passports is the authentication service). The services 301-316 can communicate with one another via a service-to-service communications protocol (SSCP), described below. As also described below, each service presents itself as a set of XML documents that can be manipulated from an application program 202 (FIG. 2) or the like using a set of standard methods and domain-specific methods. To this end, a user device 320 (endpoint) running such application programs connects a user's applications to the services, and the data controlled by those services, such as over the Internet or an Intranet, such as over the Internet or an Intranet. Note that endpoints can be client devices, applications or services. In keeping with the present invention, virtually any device capable of executing software and connecting to a network in any means may thus give a user access to data that the user is allowed to access, such as the user's own data, or data that a friend or colleague has specified as being accessible to that particular user.

In general, a NET Identity is an identifier assigned to an individual, a group of individuals, or some form of organization or project. Using this identifier, services bound to that identity can be located and manipulated. A general effect is that each identity (e.g., of a user, group or organization) has tied to it a set of services that are partitioned along schema boundaries and across different identities. As will be understood, the XML-document-centric architecture of .NET My Services provides a model for manipulating and communicating service state that is very different from prior data access models. The XML-document-centric approach, in conjunction with loose binding to the data exposed by the services, enables new classes of application programs. As will also be understood, the NET My Services model 300 presents the various services 301-316 using a uniform and consistent service and method model, a uniform and consistent data access and manipulation model, and a uniform and consistent security authorization model.

In a preferred implementation, the .NET My Services model 300 is based upon open Internet standards. Services are accessed by means of SOAP (Simple Object Access Protocol) messages containing an XML payload. Service input and output is expressed as XML document outlines, and each of these document outlines conform to an XML schema document. The content is available to a user interacting with the NET My Services service endpoint 320.

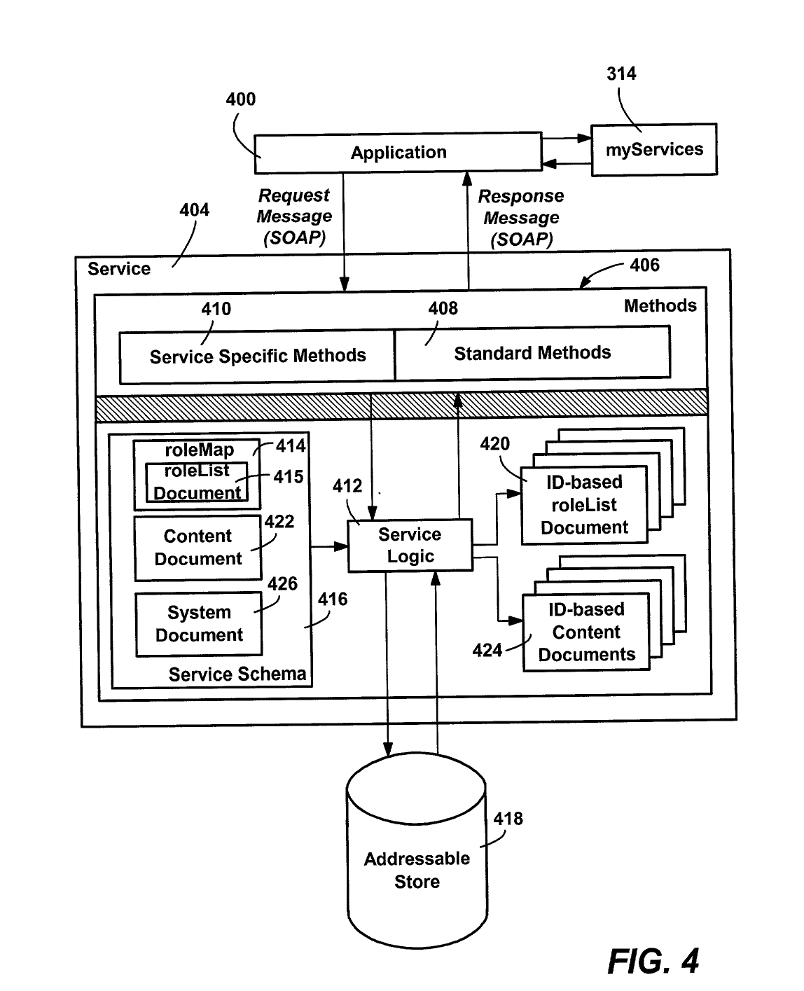

Turning to FIG. 4, in the .NET My Services model, an application 400 requests performance of a method that operates on data structures. The application may make a request that is generic with respect to the type of data structure being operated upon and without requiring dedicated executable code for manipulating data structures of any particular data type. To this end, the application first contacts a special myServices service 314 to obtain the information needed to communicate with a particular service 404, through a set of methods 406 of that service 404. For example, the needed information received from the myServices service 314 includes a URI of that service 404. Note that the service 404 may correspond to essentially any of the services represented in FIG. 3, such as the myCalendar service 303.

The service 404 includes or is otherwise associated with a set of methods 406 including standard methods 408, such as to handle requests directed to insert, delete, replace, update, query or changequery operations on the data. The set of methods of a particular service may also include service specific methods 410. In general, the only way in which an application can communicate with a service are via that service's methods.

Each service includes service logic 412 for handling requests and providing suitable responses. To this end, the service logic performs various functions such as authorization, authentication, and signature validation, and further limits valid users to only the data which they are permitted to access. The security aspect of a service is not discussed herein, except to note that in general, for otherwise valid users, the user's identity determines whether a user can access data in a requested manner. To this end, a roleMap 414 comprising service-wide roleList document templates 415 and scopes (e.g., part of the overall service's schema 416), in conjunction with user-based data maintained in an addressable store 418, determines whether a particular requested method is allowed, e.g., by forming an identity-based roleList document 420. If a method is allowed, the scope information in the roleMap 414 determines a shape of data to return, e.g., how much content is allowed to be accessed for this particular user for this particular request. The content is obtained in accordance with a content document 422 in the service's schema 416 and the actual user data corresponding to that content document in the addressable store 418. In this manner, a per-identity shaped content document 424 is essentially constructed for returning to the user, or for updating the addressable store, as appropriate for the method. Note that FIG. 4 includes a number of ID-based roleList documents and ID-based content documents, to emphasize that the service 406 is arranged to serve multiple users. Also, in FIG. 4, a system document 426 is present as part of the schema 416, as described below.

Returning to FIG. 3, in one implementation, access to .NET My Services 300 is accomplished using SOAP messages formatted with .NET My Services-specific header and body content. Each of the .NET My Services will accept these messages by means of an HTTP POST operation, and generate a response by “piggy-backing” on the HTTP Response, or by issuing an HTTP POST to a .NET My Services response-processing endpoint 320. In addition to HTTP as the message transfer protocol, .NET My Services will support raw SOAP over TCP, a transfer protocol known as Direct Internet Message Encapsulation (or DIME). Other protocols for transferring messages are feasible.

Because .NET My Services are accessed by protocol, no particular client-side binding code, object models, API layers, or equivalents are required, and are thus optional. The .NET My Services will support Web Services Description Language (WSDL). It is not mandatory that applications wishing to interact with .NET My Services make use of any particular bindings, and such bindings are not described herein. Instead, the present invention will be generally described in terms of messages that flow between requesters of a particular service and the service endpoints. In order to interact with .NET My Services, a service needs to format a .NET My Services message and deliver that message to a .NET My Services endpoint. In order to format a message, a client needs to manipulate XML document outlines, and typically perform some simple, known (public-domain) cryptographic operations on portions of the message.

In accordance with one aspect of the present invention, and as described in FIG. 4 and below, in one preferred implementation, services (including the myCalendar service 303) present three logical XML documents, a content document 422, roleList document 415 (of the roleMap 414), and a system document 426. These documents are addressable using .NET My Services message headers, and are manipulated using standard .NET My Services methods. In addition to these common methods, each service may include additional domain-specific methods, such as updateContactData.

Each .NET MyServices service thus logically includes a content document 422, which in general is the main, service-specific document. The schema for this document 422 is a function of the class of service, as will become apparent from the description of the myCalendar service's content document below. For example, in the case of the myCalendar service 303, the content document presents data in the shape dictated by the .NET My Services myCalendar schema, whereas in the case of the “.NET FavoriteWebSites” service 308, the content document presents data in the shape dictated by a .NET myFavoriteWebSites schema.

Each service also includes a roleList document 415 that contains roleList information, comprising information that governs access to the data and methods exported by the service 404. The roleList document is manipulated using the .NET My Services standard data manipulation mechanisms. The shape of this document is governed by the .NET My Services core schema's roleListType XML data type.

Each service also includes a system document 426, which contains service-specific system data such as the roleMap, schemaMap, messageMap, version information, and service specific global data. The document is manipulated using the standard .NET data manipulation mechanism, although modifications are limited in a way that allows only the service itself to modify the document. The shape of this system document 426 may be governed by the system document schema for the particular service, in that each service may extend a base system document type with service specific information.

As is understood, the present invention is generally based on schemas, which in general comprise a set of rules or standards that define how a particular type of data can be structured. Via the schemas, the meaning of data, rather than just the data itself, may be communicated between computer systems. For example, a computer device may recognize that a data structure that follows a particular address schema represents an address, enabling the computer to “understand” the component part of an address. The computer device may then perform intelligent actions based on the understanding that the data structure represents an address. Such actions may include, for example, the presentation of an action menu to the user that represents things to do with addresses. Schemas may be stored locally on a device and/or globally in a federation's “mega-store.” A device can keep a locally-stored schema updated by subscribing to an event notification service (in this case, a schema update service) that automatically passes messages to the device when the schema is updated. Access to globally stored schemas is controlled by the security infrastructure.

General Schema Commonality

The .NET My Services data is defined using annotated XSD schema files. The XSD files accurately type the data, but since XSD is a verbose and complex language, it is not a particularly efficient way to convey structure and meaning. Thus, for purposes of simplicity herein, the myCalendar schemas are described below in terms of schema outlines with accompanying element/attribute descriptions. These document outlines accurately show the structure of the data contained within a service. However, because the present application is not viewable in color, the nodes, elements and/or attributes of the schema outlines (which may be described as bold blue, or blue), are represented in the schema outlines as boldface type. Those described as underlined red, or red, are represented as underlined type, while others referred to as black are represented in normal type.

The meaning of these bold (blue), underlined (red) and normal (black) items has significance with respect to the data model and to the data language that accesses and manipulates the data (e.g., via the insert, delete, replace, update, query, changequery or other methods). For example, each document described below contains a root element having an element name that matches that of the service, e.g., the myCalendar service has a root element named myCalendar. The .NET My Services name for this item is the root.

Documents contain elements that resemble first-class top-level objects, including, for example, <catDef/>, <myApplicationsSettings/> (other another name as appropriate) and <order/>. Such items are denoted in the outlines as bold (blue), and may be identified using an <xdb:blue/> tag. Bold (blue) items define major blocks of data within a service. These node sets are directly addressable by an identifier attribute, and their change status is tracked through a changeNumber attribute. Top-level bold blue items may be considered objects. As seen below, some bold (blue) objects contain nested bold blue objects. They usually contain frequently changing underlined (red) properties, which reduces the amount of synchronization traffic. Nested bold (blue) items may be considered property groups.

Each bold blue item contains one or more underlined (red) items which are elements or attributes. These items may be identified using the <xdb:red/> tag. These items are special in that they may be used within predicates (filters) to aid in xdb:bold blue selection. These items are also directly addressable and may be manipulated directly by the data manipulation language.

Each colored red element may contain one or more non-colorized elements and attributes, which are valid and semantically meaningful XML items in the service document. Such items are opaque to the data language. These uncolored (i.e., non-bold or underlined) elements and attributes may not be addressed directly, may not be selected in a node selection operation, and may not be used in a predicate node test. Note that if one of these items is in the path to an underlined red item, it may be used in a location step to the underlined red item, but may not be used as the selected node. Note that being opaque does not mean that the item is not considered during schema validation, but rather means that the item may not be used in a predicate, may not be directly addressed, and may not be inserted by itself. As can be readily appreciated, in this manner, the .NET My Services thus limits the granularity of access to nodes within the service document, since only xdb:bold blue and xdb:underlined red marked items are directly addressable, and only those elements and attributes tagged with the xdb:underlined red annotation may be used in predicates to influence node selection. Using this technique, the .NET My Services storage system can efficiently manage indexes, increase the performance of node selection, partially shred the document data, and in general (because the node selections are well defined) fine-tune the node selection logic on a per-xdb:blue basis. The primary purpose of the xdb:blue is to define a base-level XML object that is designed to be operated on as a unit. The primary purpose of the xdb:red items is to aid in the selection of xdb:bold blues. The xdb:red items may be changed by the data language primitives so some level of fine-grained manipulation of the data is available, but only in very limited ways.

Bold blue items have unique IDs, which are usually assigned by .NET My Services, and are returned from update operations within the new blueId node. In all cases, the order of xxxBold blue follows the pre-order traversal of the document XML tree. Item IDs are UUIDs in the following format (h stands for a hexadecimal digit): hhhhhhhh-hhhh-hhhh-hhhh-hhhhhhhhhhhh.

In addition to identifiers, names and change numbers, nodes and especially red nodes may include creator identifiers, category information, and {any} fields. Category information enables data to be grouped and/or distinguished in some way, such as to share certain calendar information with golf buddies, send an email to immediately family, designate things such as which telephone number is the user's primary number, e.g., if a user has a second home, and so on. Fields of type “any” may comprise fully-typed, namespace-qualified fields that contain any type of content (e.g., free-form XML) therein. Such “any” fields thus allow extensibility of the schema, yet maintain the defined structure of a schema.

In one implementation, the core data-manipulation language implemented by the .NET My Services includes an insertRequest, or insert message. This primitive inserts any schema-valid XML fragment into a selected context, thereby changing the existing state of the document. A queryRequest, or message, retrieves data, such as to retrieve a document. Multiple queries may be specified in one request, and queries that select nothing are considered successful. It is possible to assert that the number of nodes in the selection falls in a given range. This is expressed using minOccurs and maxOccurs attributes. If a minOccurs/maxOccurs test fails on any node, the request is considered unsuccessful. Note that this is different from a failure code, which would be returned, for example, for a malformed request.

A deleteRequest primitive deletes the selected nodes and all their children. Note that, just like for other requests, attributes may be selected as well as elements. Empty selections result in successful operations, similar to Query. The minOccurs/maxOccurs tests are supported wherever select is allowed.

A replaceRequest primitive (replace message) is designed to replace the content of each of the selected nodes with the specified new content. Selected nodes themselves are not affected in any way. This may be considered as an atomic delete of the content of the selected node, followed by an insert. The content (text, attributes, elements) in the selected nodes are replaced with the new item specified in this message. The node type of the selected node and of the replacement node are thus required to be the same. The changequery request essentially returns result comrpising data that has changed.

As mentioned above, each of the services includes a RoleList document and scope information that describes which users have what type of access to which data. For example, a data owner will have read/write access to his or her own data, and can provide various types of rights to that data to other users based on their IDs, (e.g., read only to some users, read write to others). Each role list identifier may be associated with a scope, by which the kinds of data stored according to a given schema can be controlled per user. For example, a user can give a friend (with one identity) access via a service to a home telephone number, home address and so forth, but can give other users (with other identities) access only to a business telephone number. In general, a scope can be defined such that that it includes everything except any specifically listed items, or excludes everything except any specifically listed items.

myCalendar

The .NET Calendar service, alternatively referred to herein as myCalendar 303, provides calendars for users. This particular service uses an XML schema to describe a typical calendar, a user's calendar store, and the methods by which calendar data is sent and received from the store.

The .NET Calendar service stores and manages the scheduling of individual and group events and appointments that are associated with an identity. This service supplies scheduling information on demand to other .NET My Services, applications, and devices. .NET Calendar can be used for regular scheduling or group collaboration. Group collaborative features include meeting delegates and role-based access to another identity's calendar.

The .NET Calendar service is designed to work with the .NET Alerts service to perform reminder alerts and meeting acceptance/decline alerts, with .NET Contacts for service distribution lists, and with .NET Inbox to send and retrieve meeting requests. .NET Inbox will forward meeting invitations to be direct booked (tentative) on attendee calendars which have the correct permissions for this behavior and will forward meeting responses that attendees send back to the organizer to update the organizer's calendar. .NET Calendar will support calendar publishing. This feature that allows users to open their calendars to other users such as friends, family members, and group lists. The .NET Calendar service uses .NET My Services to support a rich sharing model based upon the access control list, role map, and identity header.

The .NET Calendar schema format improves established existing calendar properties and standards. In addition, .NET Calendar establishes a platform for non-Gregorian calendars and additional features such as traveling time allowances for meetings. The schema is designed to be extensible to accommodate new calendar properties or additional recurrence patterns.

Throughout the following examples, an “hs” as in <hs: scope . . . > represents the namespace or schematic that may be used to interpret the corresponding element.

myCalendar/Roles

The myCalendar service controls access by using the rt0, rt1, rt2, rt3 and rt99 roleTemplates, using the following scopes:

scope allElements
<hs:scope id=7215df55-e4af-449f-a8e4-72a1f7c6a987>

<hs:shape base=t>
</hs:shape>

</hs:scope>
scope onlySelfElements
<hs:scope id=a159c93d-4010-4460-bc34-5094c49c1633>

<hs:shape base=nil>

<hs:include select=//*[@creator=‘$callerId’]/>

</hs:shape>

</hs:scope>
scope onlySelfSubscriptionElements
<hs:scope id=b7f05a6d-75cd-4958-9dfb-f532ebb17743>

<hs:shape base=nil>

<hs:include select=//subscription[@creator=‘$callerId’]/>

</hs shape>

</hs:scope>
scope onlyPublicElements
<hs:scope id=da025540-a0c0-470f-adcf-9f07e5a5ec8f>

<hs:shape base=nil>

<hs:include select=//*[cat/@ref=‘hs:public’]/>
<hs:include select=//subscription[@creator=‘$callerId’]/>

</hs:shape>

</hs:scope>

The myCalendar roleTemplate rt0 role gives complete read/write access to the information within the content document of the service being protected through this roleTemplate. The following table illustrates the available methods and the scope in effect when accessing the myCalendar service through that method while mapped to this roleTemplate:

TABLE
myCalendar roleTemplate rt0

| method | scope/name |
|---|---|
| query | allElements |
| insert | allElements |
| replace | allElements |
| delete | allElements |
| update | allElements |
| getCalendarDays | allElements |
| getFreeBusyDays | allElements |
| getQuickView | allElements |
| sendMeeting | allElements |
| respond | allElements |
| updateReminder | allElements |

The myCalendar roleTemplate rt1 role gives complete read access to all information within the content document of the service being protected through this roleTemplate. Applications mapping to this role also have a limited ability to write to information in the content document. They may create nodes in any location, but may only change/replace, or delete nodes that they created. The following table illustrates the available methods and the scope in effect when accessing the myCalendar service through that method while mapped to this roleTemplate:

TABLE
myCalendar roleTemplate rt1

| method | scope/name |
|---|---|
| query | allElements |
| insert | onlySelfElements |
| replace | onlySelfElements |
| delete | onlySelfElements |
| update | allElements |
| getCalendarDays | allElements |
| getFreeBusyDays | allElements |
| getQuickView | onlySelfElements |
| sendMeeting | onlySelfElements |
| respond | onlySelfElements |

The myCalendar roleTemplate rt2 role gives complete read access to the information within the content document of the service being protected through this roleTemplate. Applications mapping to this role have very limited write access and are only able to create and manipulate their own subscription nodes. The following table illustrates the available methods and the scope in effect when accessing the myCalendar service through that method while mapped to this roleTemplate:

TABLE
myCalendar roleTemplate rt2

| method | scope/name |
|---|---|
| query | allElements |
| insert | onlySelfSubscriptionElements |
| replace | onlySelfSubscriptionElements |
| delete | onlySelfSubscriptionElements |
| getCalendarDays | allElements |
| getFreeBusyDays | allElements |
| getQuickView | allElements |

The myCalendar roleTemplate rt3 role gives limited read access to information within the content document that is categorized as “public.” The following table illustrates the available methods and the scope in effect when accessing the myCalendar service through that method while mapped to this roleTemplate:

TABLE
myCalendar roleTemplate rt3

| method | scope/name |
|---|---|
| query | onlyPublicElements |
| getCalendarDays | onlyPublicElements |
| getFreeBusyDays | onlyPublicElements |
| getQuickView | onlyPublicElements |

The myCalendar roleTemplate rt99 blocks access to the content document. Note that lack of a role in the roleList has the same effect as assigning someone to rt99.

myCalendar/Content

The content document is an identity centric document, with its content and meaning a function of the user identifier (puid) used to address the service. Accessing the document is controlled by the associated roleList document. The following table comprises a schema outline that illustrates the layout and meaning of the information found in the content document for the myCalendar service:

<m:myCalendar changeNumber=“...” instanceId=“...”

xmlns:m=“http://schemas.microsoft.com/hs/2001/10/myCalendar”
xmlns:hs=“http://schemas.microsoft.com/hs/2001/10/core”>_{1..1}
<m:event calendarType=“...” advanceHijriValue=“...” changeNumber=“...” id=“...”

creator=“...”>_{0..unbounded}

<m:body changeNumber=“...”>_{1..1}

<m:cat ref=“...”>_{0..unbounded}</m:cat>
<m:title xml:lang=“...” dir=“...”>_{1..1}</m:title>
<m:fullDescription xml:lang=“...” dir=“...”>_{0..1}</m:fullDescription>
<m:location xml:lang=“...” dir=“...”>_{0..1}</m:location>
<m:meetingStatus>_{0..1}</m:meetingStatus>
<m:recurrenceId>_{0..1}</m:recurrenceId>
<m:lastUpdateTime>_{0..1}</m:lastUpdateTime>
<m:startTime>_{1..1}</m:startTime>
<m:endTime>_{1..1}</m:endTime>
<m:allDay>_{0..1}</m:allDay>
<m:floating>_{0..1}</m:floating>
<m:travelTimeTo>_{0..1}</m:travelTimeTo>
<m:travelTimeFrom>_{0..1}</m:travelTimeFrom>
<m:freeBusyStatus>_{0..1}</m:freeBusyStatus>
<m:cuid>_{0..1}</m:cuid>
<m:organizer>_{0..1}

<hs:name xml:lang=“...” dir=“...”>_{0..1}</hs:name>
<hs:puid>_{0..1}</hs:puid>
<hs:email>_{0..1}</hs:email>

</m:organizer>
{any}

</m:body>
<m:attendeeEventExtra changeNumber=“...”>_{0..1}

<m:intendedFreeBusy>_{0..1}</m:intendedFreeBusy>
<m:responseTime>_{0..1}</m:responseTime>
<m:responseType>_{0..1}</m:responseType>
<m:counterPropose StartTime>_{0.1}</m:counterProposeStartTime>
<m:counterProposeEndTime>_{0..1}</m:counterProposeEndTime>
<m:counterProposeLocation>_{0..1}</m:counterProposeLocation>
<m:responseBody xml:lang=“...” dir=“...”>_{0..1}</m:responseBody>
<m:delegateResponder>_{0..1}

<hs:name xml:lang=“...” dir=“...”>_{0..1}</hs:name>
<hs:puid>_{0..1}</hs:puid>
<hs:email>_{0..1}</hs:email>

</m:delegateResponder>
{any}

</m:attendeeEventExtra>
<m:attachment changeNumber=“...” id=“...” creator=“...”>_{0..unbounded}

<m:name xml:lang=“...” dir=“...”>_{1..1}</m:name>
<m:contentType>_{1..1}</m:contentType>
<m:contentTransferEncoding>_{1..1}</m:contentTransferEnccoding>
<m:size>_{1..1}</m:size>
<m:attachmentBody>_{1..1}</m:attachmentBody>

</m:attachment>
<m:reminder changeNumber=“...” id=“...” creator=“...”>_{0..1}

<m:set>_{1..1}</m:set>
<m:to xml:lang=“...” dir=“...”>_{1..1}</m:to>
<m:offset>_{1..1}</m:offset>
<m:interruptability>_{0..1}</m:interruptability>
<m:lastSentTime>_{1..1}</m:lastSentTime>
<m:nextTriggerTime>_{1..1}</m:nextTriggerTime>

</m:reminder>
<m:attendee changeNumber=“...” id=“...” creator=“...”>_{0..unbounded}

<hs:name xml:lang=“...” dir=“...”>_{0..1}</hs:name>
<hs:puid>_{0..1}</hs:puid>
<hs:email>_{0..1}</hs:email>
<m:inviteType>_{1..1}</m:inviteType>
<m:responseTime>_{0..1}</m:responseTime>
<m:responseType>_{0..1}</m:responseType>
<m:counterProposeStartTime>_{0..1}</m:counterProposeStartTime>
<m:counterProposeEndTime>_{0..1}</m:counterProposeEndTime>
<m:counterProposeLocation>_{0..1}</m:counterProposeLocation>
<m:responseBody xml:lang=“...” dir=“...”>_{0..1}</m:responseBody>
{any}

</m:attendee>
<m:recurrence changeNumber=“...”>_{0..1}

<m:rule changeNumber=“...”>_{1..1}

<m:creationDate>_{1..1}</m:creationDate>
<m:firstDayOfWeek>_{1..1}</m:firstDayOfWeek>
<m:tzid>_{0..1}</m:tzid>
<m:isLeapYear>_{0..1}</m:isLeapYear>
<m:leapMonthValue>_{0..1}</m:leapMonthValue>
<m:repeat>_{1..1}

<m:daily dayFrequency=“...”>_{0..1}</m:daily>
<m:weekly su=“...” mo=“...” tu=“...” we=“...” th=“...” fr=“...” sa=“...”

weekFrequency=“...”>_{0..1}</m:weekly>

<m:monthlyByDay su=“...” mo=“...” tu=“...” we=“...” th=“...” fr=“...” sa=“...”

monthFrequency=“...” weekdayOfMonth=“...”>_{0..1}</m:monthlyByDay>

<m:monthly monthFrequency=“...” day=“...” forceExact=“...”>_{0.1}</m:monthly>
<m:yearlyByDay su=“...” mo=“...” tu=“...” we=“...” th=“...” fr=“...” sa=“...”

yearFrequency=“...” weekdayOfMonth=“...” month=“...”>_{0..1}</m:yearlyByDay>

<m:yearly yearFrequency=“...” month=“...” day=“...”

forceExact=“...”>_{0..1}</m:yearly>

{any}

</m:repeat>
<m:windowEnd>_{0..1}</m:windowEnd>
<m:repeatForever>_{0..1}</m:repeatForever>
<m:repeatInstances>_{0..1}</m:repeatInstances>
<m:deletedExceptionDate>_{0..unbounded}</m:deletedExceptionDate>
{any}

</m:rule>
<m:exception changeNumber=“...” id=“...” creator=“...”>_{0..unbounded}

<m:recurrenceId>_{1..1}</m:recurrenceId>
<m:body>_{0..1}

<m:title xml:lang=“...” dir=“...”>_{0..1}</m:title>
<m:fullDescription xml:lang=“...” dir=“...”>_{0..1}</m:fullDescription>
<m:location xml:lang=“...” dir=“...”>_{0..1}</m:location>
<m:startTime>_{0..1}</m:startTime>
<m:endTime>_{0..1}</m:endTime>
<m:allDay>_{0..1}</m:allDay>
<m:travelTimeTo>_{0..1}</m:travelTimeTo>
<m:travelTimeFrom>_{0..1}</m:travelTimeFrom>
<m:freeBusyStatus>_{0..1}</m:freeBusyStatus>
<m:organizer>_{0..1}

<hs:name xml:lang=“...” dir=“...”>_{0..1}</hs:name>
<hs:puid>_{0..1}</hs:puid>
<hs:email>_{0..1}</hs:email>

</m:organizer>

</m:body>
<m:attendeeEventExtra>_{0..1}

<m:intendedFreeBusy>_{0..1}</m:intendedFreeBusy>
<m:responseTime>_{0..1}</m:responseTime>
<m:responseType>_{0..1}</m:responseType>
<m:counterProposeStartTime>_{0..1}</m:counterProposeStartTime>
<m:counterProposeEndTime>_{0..1}</m:counterProposeEndTime>
<m:counterProposeLocation>_{0..1}</m:counterProposeLocation>
<m:responseBody xml:lang=“...” dir=“...”>_{0..1}</m:responseBody>
<m:delegateResponder>_{0..1}

<hs:name xml:lang=“...” dir=“...”>_{0..1}</hs:name>
<hs:puid>_{0..1}</hs:puid>
<hs:email>_{0..1}</hs:email>

</m:delegateResponder>
{any}

</m:attendeeEventExtra>
<m:deletedAttendee>_{0..unbounded}</m:deletedAttendee>
<m:deletedAttachment>_{0..unbounded}</m:deletedAttachment>
<m:attachment>_{0..unbounded}

<m:name xml:lang=“...” dir=“...”>_{1..1}</m:name>
<m:contentType>_{1..1}</m:contentType>
<m:contentTransferEncoding>_{1..1}</m:contentTransferEncoding>
<m:size>_{1..1}</m:size>
<m:attachmentBody>_{1..1}</m:attachmentBody>

</m:attachment>
<m:attendee>_{0.unbounded}

<hs:name xml:lang=“...” dir=“...”>_{0..1}</hs:name>
<hs:puid>_{0..1}</hs:puid>
<hs:email>_{0..1}</hs:email>
<m:inviteType>_{1..1}</m:inviteType>
<m:responseTime>_{0..1}</m:responseTime>
<m:responseType>_{0..1}</m:responseType>
<m:counterPropose StartTime>_{0..1}</m:counterProposeStartTime>
<m:counterProposeEndTime>_{0..1}</m:counterProposeEndTime>
<m:counterProposeLocation>_{0..1}</m:counterProposeLocation>
<m:responseBody xml:lang=“...” dir=“...”>_{0..1}</m:responseBody>
{any}

</m:attendee>
<m:reminder>_{0..1}

<m:set>_{0..1}</m:set>
<m:offset>_{0..1}</m:offset>
<m:interruptability>0.1</m:interruptability>

</m:reminder>
{any}

</m:exception>
{any}

</m:recurrence>

<m:event>
<m:subscription changeNumber=“...” id=“...” creator=“...”>_{0..unbounded}

<hs:trigger select=“...” mode=“...” baseChangeNumber=“...”>_{1..1}</hs:trigger>
<hs:expiresAt>_{0..1}</hs:expiresAt>
<hs:context uri=“...”>_{1..1} {any}</hs:context>
<hs:to>_{1..1}</hs:to>

</m:subscription>
{any}

</m:myCalendar>

The meaning of the attributes and elements shown in the table are set forth below, wherein in the syntax used in the table, boldface type corresponds to a blue node, and underlined type to a red node, as described above, and the minimum occurrence information (0, 1) indicates whether an element or attribute is required or optional, and maximum occurrence information (1, unbounded) indicates whether one or many are possible.

The /myCalendar (minOccurs=1 maxOccurs=1) element encapsulates the content document for this service. This element establishes a global cache scope for the service and contains other root level system attributes for this instance of the service. The /myCalendar/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored. The /myCalendar/@instanceId (string minOccurs=0 maxOccurs=1) attribute is a unique identifier typically assigned to the root element of a service. It is a read-only element and assigned by the .NET My Services system when a particular service is provisioned for a user.

The /myCalendar/event (minOccurs=0 maxOccurs=unbounded) event is the myCalendar root object for calendar events, appointments, and meetings.

The /myCalendar/event/@calendarType (string minOccurs=0 maxOccurs=1) field identifies an enumeration which determines the kind of calendar event this is.

| Value | Enumeration Constant | Description |
|---|---|---|
| −1 | HSCAL_ALL_CALENDARS | Unknown Calendar; system |
| | | default |
| | | (HSCAL_GREGORIAN_US) |
| 1 | HSCAL_GREGORIAN | Gregorian (localized) calendar |
| 2 | HSCAL_GREGORIAN_US | Gregorian (U.S.) calendar |
| 3 | HSCAL_JAPAN | Japanese Emperor Era calendar |
| 4 | HSCAL_TAIWAN | Taiwan Era calendar |
| 5 | HSCAL_KOREA | Korean Tangun Era calendar |
| 6 | HSCAL_HIJRI | Hijri (Arabic Lunar) calendar |
| 7 | HSCAL_THAI | Thai calendar |
| 8 | HSCAL_HEBREW | Hebrew (Lunar) calendar |
| 9 | HSCAL_GREGORIAN_ME_FRENCH | Gregorian Middle East French |
| | | calendar |
| 10 | HSCAL_GREGORIAN_ARABIC | Gregorian Arabic calendar |
| 11 | HSCAL_GREGORIAN_XLIT_ENGLISH | Gregorian Transliterated English |
| | | calendar |
| 12 | HSCAL_GREGORIAN_XLIT_FRENCH | Gregorian Transliterated French |
| | | calendar |
| 13 | HSCAL_KOREA_LUNAR | Default Korea Lunar calendar |
| 14 | HSCAL_JAPAN_LUNAR | Default Japanese Lunar calendar |
| 15 | HSCAL_CHINESE_LUNAR | Chinese Lunar calendar |
| 16 | HSCAL_SAKA | Indian Saka calendar |
| 17 | HSCAL_LUNAR_ETO_CHN | Chinese Zodiac calendar |
| 18 | HSCAL_LUNAR_ETO_KOR | Korean Zodiac calendar |
| 19 | HSCAL_LUNAR_ROKUYOU | Japanese Lucky days calendar |

The /myCalendar/event/@advanceHijriValue (int minOccurs=0 maxOccurs=1) field is required for Hijri calendar support. @advanceHijriValue ranges from {−3, −2, −1, 1, 2, 3} and is added to the current date, but the day of the week stays the same. For example, if today is the 24th and @advanceHijriValue is set to be +2, then the user sees the date as being the 26th. Typically @advanceHijriValue is +/−1, and this suffices in most cases. Theoretically it can be any number, but the worst case scenario is +/−3.

The /myCalendar/event/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myCalendar/event/@id (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myCalendar/event/@creator (minOccurs=1 maxOccurs=1) attribute identifies the creator in terms of userId, appId, and platformId of the node.

The /myCalendar/event/body (minOccurs=1 maxOccurs=1) includes the /myCalendar/event/body/@changeNumber (minOccurs=1 maxOccurs=1) changeNumber attribute, which is designed to facilitate caching of the element and its descendants. This attribute is assigned to this element by the .NET My Services system. The attribute is read only to applications. Attempts to write this attribute are silently ignored.

The /myCalendar/event/body/cat (minOccurs=0 maxOccurs=unbounded) element is used to categorize the element that contains it by referencing either a global category definition (in either the .NET Categories service system document or an external resource containing category definitions), or by referencing an identity-centered category definition in the content document of the .NET Categories service for a particular PUID.

The /myCalendar/event/body/cat/@ref (anyURI minOccurs=1 maxOccurs=1) attribute references a category definition (catDef) element using the rules outlined in the .NET Categories section, described above.

The /myCalendar/event/body/title (string minOccurs=1 maxOccurs=1) includes the /myCalendar/event/body/title/@xml:lang (minOccurs=1 maxOccurs=1) required attribute is used to specify an ISO 639 language code or an ISO 3166 country code as described in RFC 1766 (wherein ISO stands for International Organization for Standardization and RFC stands for Request For Comment). The value of this attribute indicates the language type of the content within this element. The /myCalendar/event/body/title/@dir (string minOccurs=0 maxOccurs=1) optional attribute specifies the default layout direction for the localized string. Valid values are rtl (right to left) and ltr (left to right).

The /myCalendar/event/body/fullDescription (string minOccurs=0 maxOccurs=1) element contains a free form, full description of the event. The /myCalendar/event/body/fullDescription/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/body/fullDescription/@dir (string minOccurs=0 maxOccurs=1) optional attribute specifies the base direction of directionally neutral text. Possible values include rtl (right to left) and ltr (left to right).

The /myCalendar/event/body/location (string minOccurs=0 maxOccurs=1) optional element contains the event's location. The /myCalendar/event/body/location/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/body/location/@dir (string minOccurs=0 maxOccurs=1) optional attribute specifies the default layout direction for the localized string. Valid values are rtl (right to left) and ltr (left to right).

The /myCalendar/event/body/meetingStatus (string minOccurs=0 maxOccurs=1) tracks the status of this meeting {not-sent, sent, cancelled}. A regular appointment will not have this element. If <meetingStatus> exists, this event should be rendered as a meeting, not as an appointment.

The /myCalendar/event/body/recurrenceId (dateTime minOccurs=0 maxOccurs=1) recurrence id indicates the original start time of an occurrence of a recurring master appointment. It is required to identify what instance an exception is modifying, since users are allowed to change the start time on an orphan, (wherein an an exception is a modification of an instance and an orphan is an exception that is sent as a meeting request on its own). The recurrenceId method is stored in UTC. It does not appear in the master schema, except in the specific case that an attendee is invited to an instance of a recurring event. Otherwise, <recurrenceId>_0 is usually only a part of getCalendarDays.

The /myCalendar/event/body/lastUpdateTime (dateTime minOccurs=0 maxOccurs=1) field is updated by the organizer whenever s/he creates and sends a new meeting request. This helps the attendee to identify which meeting request is the most recent one. It is stored in coordinated universal time (UTC). This property is not modifiable by clients and is assigned by the server on modification and by the sendMeetingRequest.

The /myCalendar/event/body/startTime (dateTime minOccurs=1 maxOccurs=1) startTime method defines the start time of the event. An all-day event by convention starts at 12:00:00 AM of the day of the event. This is stored in UTC. Maximum range is Jan. 1, 1753 to December 31, 9999 to an accuracy of 3.33 milliseconds. If this event is a recurring event, <startTime> defines the dateTime when the recurrence window starts. The recurring master does not have to be an instance of the recurring event itself. An event in March set to recur every April will only appear in April.

The /myCalendar/event/body/endTime (dateTime minOccurs=1 maxOccurs=1) endTime method defines the end time of the event. An all-day event by convention ends at 11:59:59 PM of the ending day. This is stored inUTC. Maximum range is Jan. 1, 1753 to December 31, 9999 to an accuracy of 3.33 milliseconds. The duration of the event is inferred from endTime−startTime.

The /myCalendar/event/body/allDay (boolean minOccurs=0 maxOccurs=1) element indicates a regular event by being false or being absent. Otherwise, this attribute indicates that the event is an all-day event. All day events may span multiple days. By convention, all day events start at 12:00:00 am of the day of startTime, regardless of what time it actually is, and it will end at 11:59:59 pm of the endTime date. In other words, if the allDay element is present and has value=true, .NET Calendar will ignore the actual times of the events and consider only the date part of the field.

The allDay tag is meant to operate as a hint to UI renders to display specialized icons indicating an all-day event. allDay events are distinguishable between 24-hr events starting at 12am. In the case of a meeting request, an allDay event will not appear in the local user's time zone, but rather in the organizer's time zone.

The /myCalendar/event/body/floating (boolean minOccurs=0 maxOccurs=1) floating attribute indicates that this event is to occur in the current local time zone no matter what time zone the system is currently in (that is, it floats). For example, holidays are floating events. As another example, it may be useful to schedule medication regardless of an actual time zone, whereby a floating attribute is used with such an event. Floating values are stored as-is: no time-zone translations are needed to convert them to UTC or any local time zone.

The /myCalendar/event/body/travelTimeTo (int minOccurs=0 maxOccurs=1) field contains the amount of time (in minutes) that it takes to travel to the meeting location. The /myCalendar/event/body/travelTimeFrom (int minOccurs=0 maxOccurs=1) field contains the amount of time (in minutes) that it takes to return from the meeting location. These optional elements show in free/busy calculations.

The /myCalendar/event/body/freeBusyStatus (string minOccurs=0 maxOccurs=1) optional element annotates the freeBusy behavior of this event. Events by default appear as “busy”. The user may explicitly define this event to be annotated by setting .NET Calendar values to free, tentative, busy or away.

The /myCalendar/event/body/cuid (string minOccurs=0 maxOccurs=1) cuid (CorrelationUID) links an organizer's event to an attendee's event. It identifies which response from an attendee is for which request from an organizer, and which meeting request update from the organizer is for which previously accepted meeting by the attendee. The “cuid” is the same on both the attendee's and the organizer's copy of the appointment. It is also identical on the exception and the recurring master, wherein an exception is a modification of an instance. This value is assigned by the .NET Calendar server and is non-modifiable.

The /myCalendar/event/body/organizer (minOccurs=0 maxOccurs=1) field contains the email address of the event organizer. The /myCalendar/event/body/organizer/name (string minOccurs=0 maxOccurs=1) optional element specifies the name for the enclosing element. The /myCalendar/event/body/organizer/name/@xml:lang (minOccurs=1maxOccurs=1) required attribute is used to specify an ISO 639 language code or an ISO 3166 country code as described in RFC 1766. The value of this attribute indicates the language type of the content within this element. The /myCalendar/event/body/organizer/name/@dir (string minOccurs=0 maxOccurs=1) optional attribute specifies the default layout direction for the localized string. Valid values are rtl (right to left) and ltr (left to right).

The /myCalendar/event/body/organizer/puid (string minOccurs=0 maxOccurs=1) optional element specifies the PUID for the enclosing element. The /myCalendar/event/body/organizer/email (string minOccurs=0 maxOccurs=1) optional name specifies an e-mail address for the enclosing element.

The /myCalendar/event/body/{any} (minOccurs=0 maxOccurs=unbounded) provides for additional body elements.

The /myCalendar/event/attendeeEventExtra (minOccurs=0 maxOccurs=1) field contains additional information about an event, found only in an event invitee's schema. The /myCalendar/event/attendeeEventExtra/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myCalendar/event/attendeeEventExtra/intendedFreeBusy (string minOccurs=0 maxOccurs=1) element is the event organizer's freeBusy information and is thus equal to event/freeBusyStatus. Invitees may overwrite event/freeBusyStatus with a new value, and intendedFreeBusy is intended to store the organizer's original freeBusyStatus.

The /myCalendar/event/attendeeEventExtra/responseTime (dateTime minOccurs=0 maxOccurs=1) field contains the reply time on each attendee is set to the current time (Now) when the organizer sends a meeting invitation. When the attendee responds, they update their responseTime. When the organizer receives responses, they will honor only those that have a higher responseTime than what is maintained in his/her own copy of the event for each attendee. While processing the response, the organizer will update their responseTime. This guarantees that the organizer honors only the most recent response from the attendee. This is stored in UTC.

The /myCalendar/event/attendeeEventExtra/responseType (string minOccurs=0 maxOccurs=1) accept status indicates the valid types of responses that an attendee can reply with {accept, decline, tentative, counterpropose}. The absence of this field indicates that no response has been recorded.

The /myCalendar/event/attendeeEventExtra/counterProposeStartTime (dateTime minOccurs=0 maxOccurs=1) field contains the counter proposal start time information. If responseType=[counterPropose], then either the startTime, endTime, or location, or all three can be present. This is the invitee's counterProposal for a new start time for the meeting. This is stored in UTC.

The /myCalendar/event/attendeeEventExtra/counterProposeEndTime (dateTime minOccurs=0 maxOccurs=1) field contains the counter proposal end time information. If responseType=[counterPropose], then either the {startTime, endTime}, or location, or both can be present. This is the invitee's counterproposal for a new end time for the meeting. This is stored in UTC.

The /myCalendar/event/attendeeEventExtra/counterProposeLocation (string minOccurs=0 maxOccurs=1) field contains the counter proposal location information. field contains the counter proposal start time information. If responseType=[counterPropose], then either the {startTime, endTime}, or location, or both can be present. This is the invitee's counterproposal for a location for the meeting.

The /myCalendar/event/attendeeEventExtra/responseBody (string minOccurs=0 maxOccurs=1) field contains an optional message for invitees to include along with the response. The /myCalendar/event/attendeeEventExtra/responseBody/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/attendeeEventExtra/responseBody/@dir (string minOccurs=0 maxOccurs=1) optional attribute specifies the base direction of directionally neutral text. Possible values include rtl (right to left) and ltr (left to right).

The /myCalendar/event/attendeeEventExtra/delegateResponder (minOccurs=0 maxOccurs=1) field stores information of a delegate who responds on behalf of an invitee. The /myCalendar/event/attendeeEventExtra/delegateResponder/name (string minOccurs=0 maxOccurs=1) optional element specifies the name for the enclosing element. The /myCalendar/event/attendeeEventExtra/delegateResponder/name/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/attendeeEventExtra/delegateResponder/name/@dir (string minOccurs=0 maxOccurs=1) optional attribute specifies the default layout direction for the localized string. Valid values are rtl (right to left) and ltr (left to right).

The /myCalendar/event/attendeeEventExtra/delegateResponder/puid (string minOccurs=0 maxOccurs=1) optional element specifies the PUID for the enclosing element. The /myCalendar/event/attendeeEventExtra/delegateResponder/email (string minOccurs=0 maxOccurs=1) optional name specifies an e-mail address for the enclosing element. The /myCalendar/event/attendeeEventExtra/{any} (minOccurs=0 maxOccurs=unbounded) provides for additional attendee extra properties.

The /myCalendar/event/attachment (minOccurs=0 maxOccurs=unbounded) element contains attachment metadata, name, content-type and id's, and may also contain the attachmentBody. The /myCalendar/event/attachment/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myCalendar/event/attachment/@id (minOccurs=1 maxOccurs=1) attribute is a globally unique ID assigned to this element by .NET My Services. Normally, .NET My Services generates and assigns this ID during an insertRequest operation, or possibly during a replaceRequest. Application software can override this ID generation by specifying the useClientIds attribute in the request message. After an ID has been assigned, the attribute is read only and attempts to write it are silently ignored.

The /myCalendar/event/attachment/@creator (minOccurs=1maxOccurs=1) attribute identifies the creator in terms of userId, appId, and platformId of the node. The /myCalendar/event/attachment/name (string minOccurs=1maxOccurs=1) element contains information about an individual attachment in a mail message. The /myCalendar/event/attachment/name/@xml:lang (minOccurs=1maxOccurs=1) required attribute is used to specify an ISO 639 language code or an ISO 3166 country code as described in RFC 1766. The value of this attribute indicates the language type of the content within this element. The /myCalendar/event/attachment/name/@dir (string minOccurs=0 maxOccurs=1) optional attribute specifies the default layout direction for the localized string. Valid values are rtl (right to left) and ltr (left to right).

The /myCalendar/event/attachment/contentType (string minOccurs=1maxOccurs=1) element contains the content type of the attachment. The /myCalendar/event/attachment/contentTransferEncoding (string minOccurs=1maxOccurs=1) element contains the encoding of the attachment. This information is necessary for decoding the attachment. The /myCalendar/event/attachment/size (unsignedLong minOccurs=1 maxOccurs=1) element contains the size of the attachment in bytes. The /myCalendar/event/attachment/attachmentBody (base64Binary minOccurs=1 maxOccurs=1) element contains the contents of the attachment.

The /myCalendar/event/reminder (minOccurs=0 maxOccurs=1) is directed to reminders. A user may optionally define a reminder for this appointment. Reminders for recurring appointments will be sent periodically before the appointment, as per the rules defined in the reminder subschema below. A non-recurring event may define no reminders, define a reminder with <set>=“true” or define a reminder with <set>=“false”.

A recurring meeting may have no reminders defined, or a recurring reminder defined with all instances receiving reminders. To define no reminders by default, but to define reminders for particular meeting instances in the exception body, a reminder <set>=“false” is created, and turned on and/or modified for particular instances. To define a recurring reminder, but turn it off for particular meeting instances, a reminder <set>=“true” is created, and turned off for particular instances.

If the event's reminder subschema is non-existent, yet the exception body has a reminder blob, then the exception reminder is ignored. An alternative is to require this.

The /myCalendar/event/reminder/@changeNumber (minOccurs=1maxOccurs=1) changeNumber attribute is designed to facilitate caching of the element and its descendants. This attribute is assigned to this element by the .NET My Services system. The attribute is read only to applications. Attempts to write this attribute are silently ignored.

The /myCalendar/event/reminder/@id (minOccurs=1maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myCalendar/event/reminder/@creator (minOccurs=1maxOccurs=1) attribute identifies the creator in terms of userId, appId, and platformId of the node. The /myCalendar/event/reminder/set (boolean minOccurs=1maxOccurs=1) field maintains a Boolean flag that indicates whether the reminder is active for this event. In most cases, this will be true, but in the case of a recurring appointment, this flag may default to true with specific instances not to be reminded, or default to false, with specific instances to be reminded.

The /myCalendar/event/reminder/to (string minOccurs=1maxOccurs=1) stores a friendly name that this reminder is being sent to. The /myCalendar/event/reminder/to/@xml:lang (minOccurs=1maxOccurs=1) required attribute is used to specify an ISO 639 language code or an ISO 3166 country code as described in RFC 1766. The value of this attribute indicates the language type of the content within this element. The /myCalendar/event/reminder/to/@dir (string minOccurs=0 max0ccurs=1) optional attribute specifies the default layout direction for the localized string. Valid values are rtl (right to left) and ltr (left to right).

The /myCalendar/event/reminder/offset (int minOccurs=1maxOccurs=1) field specifies the offset, in minutes, of how long before the event the user should be reminded. Recommended values are set forth in the following table:

| Value | Description |
|---|---|
| 5, 10, 20, 30, 45 | 5, 10, 20, 30, 45 minutes before the event |
| 60, 120, 180, | 1, 2, 3 hours before the event |
| startTime-startDay | The day of the event (reminder sent at |
| | 12:00 am) |
| startTime-(startDay-(1440* | “x” days before the event (reminder sent |
| x)) | at 12:00 am “x” days before) |

The /myCalendar/event/reminder/interruptability (int minOccurs=0 maxOccurs=1) optional element defines how interruptible this event is and it is used by notification routing software to make decisions about the relay and deferral of notifications that might occur while this meeting is active. The value contained in this element is a numeric value between one and ten. Low values represent a high cost of disruption, high values represent a low cost of disruption.

The /myCalendar/event/reminder/lastSentTime (dateTime minOccurs=1 maxOccurs=1) field is required by the reminder engine. The /myCalendar/event/reminder/nextTriggerTime (dateTime minOccurs=1maxOccurs=1) determines the next time to trigger reminder.

The /myCalendar/event/attendee (minOccurs=0 maxOccurs=unbounded) includes the attendeeType, which contains the information about an attendee, including the display, email, puid, and the attendee's response.

The /myCalendar/event/attendee/@changeNumber (minOccurs=1maxOccurs=1) changeNumber attribute is designed to facilitate caching of the element and its descendants. This attribute is assigned to this element by the .NET My Services system. The attribute is read only to applications. Attempts to write this attribute are silently ignored.

The /myCalendar/event/attendee/@id (minOccurs=1maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myCalendar/event/attendee/@creator (minOccurs=1maxOccurs=1) attribute identifies the creator in terms of userId, appId, and platformId of the node. The /myCalendar/event/attendee/name (string minOccurs=0 maxOccurs=1) optional element specifies the name for the enclosing element. The /myCalendar/event/attendee/name/@xml:lang (minOccurs=1maxOccurs=1) required attribute is used to specify an ISO 639 language code or an ISO 3166 country code as described in RFC 1766. The value of this attribute indicates the language type of the content within this element. The /myCalendar/event/attendee/name/@dir (string minOccurs=0 maxOccurs=1) optional attribute specifies the default layout direction for the localized string. Valid values are rtl (right to left) and ltr (left to right).

The /myCalendar/event/attendee/puid (string minOccurs=0 maxOccurs=1) optional element specifies the PUID for the enclosing element. The /myCalendar/event/attendee/email (string minOccurs=0 maxOccurs=1) optional name specifies an e-mail address for the enclosing element. The /myCalendar/event/attendee/inviteType (string minOccurs=1 maxOccurs=1) is used by a meeting organizer to define the kind of invitee, e.g., as required, optional, or a resource (e.g., meeting room).

The /myCalendar/event/attendee/responseTime (dateTime minOccurs=0 maxOccurs=1) reply time on each attendee is set to the current time (Now) when the organizer sends a meeting invitation. When the attendee responds, they update their responseTime. When the organizer receives responses, they will honor only those that have a higher responseTime than what s/he maintains in his/her own copy of the event for each attendee. While processing the response, the organizer will update their responseTime. This guarantees that the organizer honors only the most recent response from the attendee. This is stored in UTC.

The /myCalendar/event/attendee/counterProposeStartTime (dateTime minOccurs=0 maxOccurs=1) field contains the counter proposal start time information. If responseType=[counterPropose], then either the {startTime, endTime}, or location, or both can be present. This is the invitee's counterproposal for a new start time for the meeting. This is stored in UTC.

The /myCalendar/event/attendee/counterProposeEndTime (dateTime minOccurs=0 maxOccurs=1) field contains the counter proposal end time information. If responseType=[counterPropose], then either the {startTime, endTime}, or location, or both can be present. This is the invitee's counterproposal for a new end time for the meeting. This is stored in UTC.

The /myCalendar/event/attendee/counterProposeLocation (string minOccurs=0 maxOccurs=1) field contains the counter proposal location information. field contains the counter proposal start time information. If responseType=[counterPropose], then either the {startTime, endTime}, or location, or both can be present. This is the invitee's counterproposal for a location for the meeting.

The /myCalendar/event/attendee/responseBody (string minOccurs=0 maxOccurs=1) field contains an optional message for invitees to include along with the response. The /myCalendar/event/attendee/responseBody/@xml:lang (minOccurs=1maxOccurs=1) required attribute is used to specify an ISO 639 language code or an ISO 3166 country code as described in RFC 1766. The value of this attribute indicates the language type of the content within this element. The /myCalendar/event/attendee/responseBody/@dir (string minOccurs=0 maxOccurs=1) optional attribute specifies the base direction of directionally neutral text. Possible values include rtl (right to left) and ltr (left to right).

The /myCalendar/event/attendee/{any} (minOccurs=0 maxOccurs=unbounded) allows for extensibility.

The /myCalendar/event/recurrence (minOccurs=0 maxOccurs=1) includes /myCalendar/event/recurrence/@changeNumber (minOccurs=1maxOccurs=1) changeNumber attribute, designed to facilitate caching of the element and its descendants. This attribute is assigned to this element by the .NET My Services system. The attribute is read only to applications. Attempts to write this attribute are silently ignored.

The /myCalendar/event/recurrence/rule (minOccurs=1maxOccurs=1) includes the /myCalendar/event/recurrence/rule/@changeNumber (minOccurs=1maxOccurs=1) changeNumber attribute, designed to facilitate caching of the element and its descendants. This attribute is assigned to this element by the .NET My Services system. The attribute is read only to applications. Attempts to write this attribute are silently ignored.

The /myCalendar/event/recurrence/rule/creationDate (dateTime minOccurs=1 maxOccurs=1) is required in order to exactly determine which timezone recurrence rule to use. The startTime of the event is not used because of the ability to create events in the past and in the future.

The /myCalendar/event/recurrence/rule/firstDayOfWeek (string minOccurs=1 maxOccurs=1) stores what the first day of the week (DOW) is for this user. Typical values are (su) Sunday or (mo) Monday. This maintains a recurrence rule's specified FirstDOW (for calculating the recurrence expansion. Allows recurring meetings to be expanded in the organizer's FirstDOW instead of the invitee's FirstDOW.

The /myCalendar/event/recurrence/rule/tzid (int minOccurs=0 maxOccurs=1) identifies the time zone for this recurring event. The dateTime information in this event is stored in UTC (converted from the local time zone defined by the time zone sub-schema). If this field is absent, the recurring event is assumed to be recurring in UTC time. However, it is only a floating recurring event if the <floating> attribute is set, as described above. @afterDay is currently used, but is optional.

The /myCalendar/event/recurrence/rule/isLeapYear (boolean minOccurs=0 maxOccurs=1) provides International calendar support. It is possible to derive isLeapYear from leapMonthValue, but .NET Calendar stores both separately. The /myCalendar/event/recurrence/rule/leapMonthValue (int minOccurs=0 maxOccurs=1) <leapMonthValue> cannot be derived from a particular year and thus must be stored. For example, a user creates a recurrence on a Hebrew Lunar calendar. The year is a leap year and it has 13 months. In that year, the leapMonthValue is 7.

The /myCalendar/event/recurrence/rule/repeat (minOccurs=1maxOccurs=1) may includes the /myCalendar/event/recurrence/rule/repeat/daily (minOccurs=0 maxOccurs=1), field, which specifies the number of days to repeat, e.g., repeat every [. . . ] days. The /myCalendar/event/recurrence/rule/repeat/daily/@dayFrequency (int minOccurs=1 max Occurs=1) specifies the periodicity of days over which repetition occurs, for example, repeat every 3 days.

The /myCalendar/event/recurrence/rule/repeat/weekly (minOccurs=0 maxOccurs=1) field, if present, is directed to repeating weekly, e.g., repeat every [. . . ] week(s) on {su, mo, tu, we, th, fr, sa}. The presence of a weekday attribute means to repeat on this particular day. Any combination of the seven days is valid.

The /myCalendar/event/recurrence/rule/repeat/weekly/@weekFrequency (int minOccurs=0 maxOccurs=1) repeatWeekly recurrence occurs every period of weeks. If the attribute is not present, it defaults to 1 (every week).

The /myCalendar/event/recurrence/rule/repeat/monthlyByDay (minOccurs=0 maxOccurs=1) specifies to repeat on the [First, Second, Third, Fourth, Last] {su, mo, tu, we, th, fr, sa} of every [. . . ] month(s). Any combination of the {weekday} attributes are valid, including user-defined combinations for weekdays and weekend days.

The /myCalendar/event/recurrence/rule/repeat/monthlyByDay/@monthFrequency (int minOccurs=0 maxOccurs=1) specifies the month periodicity to recur on. If this attribute is not present, it defaults to 1 (every month).

The /myCalendar/event/recurrence/rule/repeat/monthlyByDay/@weekdayOfMonth (string minOccurs=1maxOccurs=1) specifies which week in a month [first, second, third, fourth, last].

The /myCalendar/event/recurrence/rule/repeat/monthly (minOccurs=0 maxOccurs=1) repeats the occurrence every month on a particular day. The very first occurrence is created from the parent event's startTime and endTime, but the recurrence occurs as follows: Repeat every month on [day] of [month]. Repeat every [monthFrequency] month(s) on [day] of [month]. Typically, the first occurrence is also an instance of the recurrence, but this need not be the case.

The /myCalendar/event/recurrence/rule/repeat/monthly/@monthFrequency (int minOccurs=0 maxOccurs=1) optional attribute indicates the month periodicity. By default, it is 1, periodic every month. The start of the periodicity is determined from event startTime. The /myCalendar/event/recurrence/rule/repeat/monthly/@day (int minOccurs=1 maxOccurs=1) specifies the day of the month to recur on. Value is between one and 31.

A forceExact rule handles invalid day-month combinations. The proper recurrence pattern for repeating on the last day of the month is to use repeatMonthlyByDay. “Repeat on the [last] [day, weekday, weekend day] of . . . ”. By default, an invalid day-month combination will cause .NET Calendar to search backwards to find a valid day-month combination. If /myCalendar/event/recurrence/rule/repeat/monthly/@forceExact (boolean minOccurs=0 maxOccurs=1) is true, an invalid starting [month ,day] combination such as [6, 31] is ignored and will not be included as an instance of the recurrence. With forceExact, day=31 will only pick up months that have 31 days, day=30 will pick up all months except February, day=29 will pick up all months except February, except on leap years. February 29 is included on leap years.

The /myCalendar/event/recurrence/rule/repeat/yearlyByDay (minOccurs=0 maxOccurs=1) specifies how to repeat on the [First, Second, Third, Fourth, Last] {su, mo, tu, we, th, fr, sa} of [Jan, Feb, Mar, Apr, May, Jun, Jul, Aug, Sep, Oct, Nov, Dec] every [yearFrequency] years.

Any combination of the {weekday} attributes are valid, including user-defined combinations denoting weekdays and weekend days. This element's attributes contain whether a given day is or is not considered by the user as part of the work week. If this element has no attributes, it is assumed that the user has a Monday to Friday work week.

The /myCalendar/event/recurrence/rule/repeat/yearlyByDay/@yearFrequency (int minOccurs=0 maxOccurs=1) optional attribute indicates the year periodicity. By default, it is I (repeat every year).

The /myCalendar/event/recurrence/rule/repeat/yearlyByDay/@weekdayOfMonth (string minOccurs=1maxOccurs=1) Specifies which week in a month [first, second, third, fourth, last] to repeat.

The /myCalendar/event/recurrence/rule/repeat/yearlyByDay/@month (int minOccurs=1maxOccurs=1) contains a value between one and thirteen (some calendars have thirteen months).

The /myCalendar/event/recurrence/rule/repeat/yearly (minOccurs=0 maxOccurs=1) specifies to repeat every year on a particular date. The very first occurrence is created from the parent event's startTime and endTime, but the recurrence occurs as follows: Repeat yearly on [day] of [month]. Repeat every [yearFrequency] years on [day] of [month]. Typically, the first occurrence is also an instance of the recurrence, but this need not be the case.

The /myCalendar/event/recurrence/rule/repeat/yearly/@yearFrequency (int minOccurs=0 maxOccurs=1) optional attribute indicates the year periodicity. By default, it is 1 (repeat every year). The /myCalendar/event/recurrence/rule/repeat/yearly/@month (int minOccurs=1maxOccurs=1) specifies the month to recur on.

The /myCalendar/event/recurrence/rule/repeat/yearly/@day (int minOccurs=1 maxOccurs=1) specifies the day of the month to recur on. The value is between 1-31, and forceExact, applies for invalid day-month combinations. Thus, by default, an invalid day-month-year combination will cause .NET Calendar to search backwards to find a valid day for a particular month, year. If /myCalendar/event/recurrence/rule/repeat/yearly/@forceExact (boolean minOccurs=0 maxOccurs=1) is true, an invalid starting [month ,day] combination such as [6, 31] is ignored and will not be included as an instance of the recurrence. With forceExact, .NET Calendar, day=31 will only pick up months that have 31 days, day=30 will pick up all months except February, day=29 will pick up all months except February, except on leap years. February 29 is included on leap years.

The /myCalendar/event/recurrence/rule/repeat/{any} (minOccurs=0 maxOccurs=unbounded) allows for any additional repeat rules.

The /myCalendar/event/recurrence/rule/windowEnd (dateTime minOccurs=0 maxOccurs=1) field indicates the end of the window over which the recurrence occurs. This is stored in UTC. The Maximum range is Jan. 1, 1753 to December 31, 9999 to an accuracy of 3.33 milliseconds. Note that windowEnd, repeatForever, repeatInstances may be selectable.

The /myCalendar/event/recurrence/rule/repeatForever (boolean minOccurs=0 maxOccurs=1) overrides the windowEnd date and specifies that this recurrence repeats forever. Client implementations cannot depend on date values repeating forever, like 23:59:59 pm Dec 31, 9999 or 23:59 Aug 31, 4500.

The /myCalendar/event/recurrence/rule/repeatlnstances (int minOccurs=0 maxOccurs=1) overrides the windowEnd date and specifies that this recurrence repeats for the specified number of instances. As is apparent, repeatInstances and repeatForever are mutually exclusive, but repeatInstances will override repeatForever for errant schemas.

The /myCalendar/event/recurrence/rule/deletedExceptionDate (dateTime minOccurs=0 maxOccurs=unbounded) allows exceptions to a recurrence rule, which are added as an element list of dates. In general, the purpose of deletedExceptionDate is to prevent an instance/occurrence from being generated during expansion of the series. The myCalendar service logic ignores the hh:mm:ss of the dateTime and merely blocks out the particular day. Any days can be added to an exception rule, including days where no occurrences of a recurrence rule would fall in the first place. This is stored in UTC.

The /myCalendar/event/recurrence/rule/{any} (minOccurs=0 maxOccurs=unbounded) provides for additional recurrence rule logic that cannot be expressed in .NET Calendar logic.

The /myCalendar/event/recurrence/exception (minOccurs—0 maxOccurs=unbounded) field contains a list of modified event properties for this particular orphan event. The properties that are not modified are inherited from the original event upon recurrence expansion (client-side). A recurrenceId is always present, and is used to determine which instance of the original rule this modifiedException applies to.

The /myCalendar/event/recurrence/exception/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myCalendar/event/recurrence/exception/@id (minOccurs=1maxOccurs=1) attribute is a globally unique ID assigned to this element by .NET My Services. Normally, NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myCalendar/event/recurrence/exception/@creator (minOccurs=1maxOccurs=1) attribute identifies the creator in terms of userId, appId, and platformId of the node. The /myCalendar/event/recurrence/exception/recurrenceId (dateTime minOccurs=1maxOccurs=1) field contains the original start time (recurrenceId) of the occurrence that is being modified by this exception. ModifiedExceptions with recurrenceIds that do not match the recurrenceId of any occurrence are ignored. This is stored in UTC. Note that modifiedException does not expose the id attribute; the recurrenceId should be used to predicate instead, as it functions as the id of modifiedException.

The /myCalendar/event/recurrence/exception/body (minOccurs=0 maxOccurs=1) field contains the modifiable properties of the eventBody. The /myCalendar/event/recurrence/exception/body/title (string minOccurs=0 maxOccurs=1) allows for title changes. The /myCalendar/event/recurrence/exception/body/title/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/recurrence/exceptionlbody/title/@dir (string minOccurs=0 maxOccurs=1) optional attribute specifies the default layout direction for the localized string. Valid values are rtl (right to left) and ltr (left to right).

The /myCalendar/event/recurrence/exception/body/fullDescription (string minOccurs=0 maxOccurs=1) provides for a a revised description. The /myCalendar/event/recurrence/exception/body/fullDescription/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/recurrence/exception/body/fullDescription/@dir (string minOccurs=0 maxOccurs=1) optional attribute specifies the base direction of directionally neutral text. Possible values include rtl (right to left) and ltr (left to right).

The /myCalendar/event/recurrence/exception/body/location (string minOccurs=0 maxOccurs=1) allows for a meeting location to be switched, for this instance only (not recurring instances). The /myCalendar/event/recurrence/exception/body/location/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/recurrence/exception/body/location/@dir (string minOccurs=0 maxOccurs=1) optional attribute specifies the default layout direction for the localized string. Valid values are rtl (right to left) and ltr (left to right).

The /myCalendar/event/recurrence/exception/body/startTime (dateTime minOccurs=0 maxOccurs=1), if present, switches the start time, again for this instance only. The /myCalendar/event/recurrence/exception/body/endTime (dateTime minOccurs=0 maxOccurs=1) switches the end time for this instance only.

The /myCalendar/event/recurrence/exception/body/allDay (boolean minOccurs=0 maxOccurs=1) specifies that this particular instance is allDay. The /myCalendar/event/recurrence/exception/body/travelTimeTo (int minOccurs=0 maxOccurs=1) can adjust the travel to time for this instance, such as if traffic is a problem. The /myCalendar/event/recurrence/exception/body/travelTimeFrom (int minOccurs=0 maxOccurs=1) can adjust the travel from time for this instance.

The /myCalendar/event/recurrence/exception/body/freeBusyStatus (string minOccurs=0 maxOccurs=1) handles a priority is changed for this meeting instance.

The /myCalendar/event/recurrence/exception/body/organizer (minOccurs=0 maxOccurs=1) field will be present when the original organizer is replaced by another organizer.

The /myCalendar/event/recurrence/exception/body/organizer/name (string minOccurs=0 maxOccurs=1) optional element specifies the name for the enclosing element. The /myCalendar/event/recurrence/exception/body/organizer/name/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/recurrence/exception/body/organizer/name/@dir (string minOccurs=0 maxOccurs=1) optional attribute specifies the default layout direction for the localized string. Valid values are rtl (right to left) and ltr (left to right).

The /myCalendar/event/recurrence/exception/body/organizer/puid (string minOccurs=0 maxOccurs=1) optional element specifies the PUID for the enclosing element. The /myCalendar/event/recurrence/exception/body/organizer/email (string minOccurs=0 maxOccurs=1) optional name specifies an e-mail address for the enclosing element. The /myCalendar/event/recurrence/exception/attendeeEventExtra (minOccurs=0 maxOccurs=1) provides for additional information about an event, found only in an event invitee's schema.

The /myCalendar/event/recurrence/exception/attendeeEventExtra/intendedFreeBusy (string minOccurs=0 maxOccurs=1) intendedFreeBusy element is the event organizer's freeBusy information, and is thus equal to event/freeBusyStatus. Invitees may overwrite event/freeBusyStatus with a new value, and intendedFreeBusy is intended to store the organizer's original freeBusyStatus.

The /myCalendar/event/recurrence/exception/attendeeEventExtra/responseTime (dateTime minOccurs=0 maxOccurs=1) reply time on each attendee is set to the current time (Now) when the organizer sends a meeting invitation. When the attendee responds, they update their responseTime. When the organizer receives responses, they will honor only those that have a higher responseTime than what is maintained in his/her own copy of the event for each attendee. While processing the response, the organizer will update their responseTime. This guarantees that the organizer honors only the most recent response from the attendee. This is stored in UTC.

The /myCalendar/event/recurrence/exception/attendeeEventExtra/responseType (string minOccurs=0 maxOccurs=1) accept status indicates the valid types of responses that an attendee can reply with {accept, decline, tentative, counterpropose}. The absence of this field indicates that no response has been recorded.

The /myCalendar/event/recurrence/exception/attendeeEventExtra/counterProposeStartTime (dateTime minOccurs=0 maxOccurs=1) field contains the counter proposal start time information. If responseType=[counterPropose], then either the {startTime, endTime}, or location, or both can be present. This is the invitee's counterproposal for a new start time for the meeting. This is stored in UTC.

The /myCalendar/event/recurrence/exception/attendeeEventExtra/counterProposeEndTime (dateTime minOccurs=0 maxOccurs=1) field contains the counter proposal end time information. If responseType=[counterPropose], then either the {startTime, endTime}, or location, or both can be present. This is the invitee's counterproposal for a new end time for the meeting. This is stored in UTC.

The /myCalendar/event/recurrence/exception/attendeeEventExtra/counterProposeLocation (string minOccurs=0 maxOccurs=1) field contains the counter proposal location information. field contains the counter proposal start time information. If responseType=[counterPropose], then either the {startTime, endTime}, or location, or both can be present. This is the invitee's counterProposal for a location for the meeting.

The /myCalendar/event/recurrence/exception/attendeeEventExtra/responseBody (string minOccurs=0 maxOccurs=1) field contains an optional message for invitees to include along with the response. The /myCalendar/event/recurrence/exception/attendeeEventExtra/responseBody/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/recurrence/exception/attendeeEventExtra/responseBody/@dir (string minOccurs=0 maxOccurs=1) optional attribute specifies the base direction of directionally neutral text. Possible values include rtl (right to left) and ltr (left to right).

The /myCalendar/event/recurrence/exception/attendeeEventExtra/delegateResponder (minOccurs=0 maxOccurs=1), when present, is for a delegate who responds on behalf of an invitee; the delegate will have their information stored here.

The /myCalendar/event/recurrence/exception/attendeeEventExtra/delegateResponder/name (string minOccurs=0 maxOccurs=1) optional element specifies the name for the enclosing element. The /myCalendar/event/recurrence/exception/attendeeEventExtra/delegateResponder/name/@xml: lang (minOccurs=1maxOccurs=1) required attribute is used to specify an ISO 639 language code or an ISO 3166 country code as described in RFC 1766. The value of this attribute indicates the language type of the content within this element. The /myCalendar/event/recurrence/exception/attendeeEventExtra/delegateResponder/name/@dir (string minOccurs=0 maxOccurs=1) optional attribute specifies the default layout direction for the localized string. Valid values are rtl (right to left) and ltr (left to right).

The /myCalendar/event/recurrence/exception/attendeeEventExtra/delegateResponder/puid (string minOccurs=0 maxOccurs=1) optional element specifies the PUID for the enclosing element. The /myCalendar/event/recurrence/exception/attendeeEventExtra/delegateResponder/email (string minOccurs=0 maxOccurs=1) optional name specifies an e-mail address for the enclosing element. The /myCalendar/event/recurrence/exception/attendeeEventExtra/{any} (minOccurs=0 maxOccurs=unbounded) allows for additional attendee extra properties.

The meeting organizer of a recurring meeting may wish to exclude a particular attendee for an instance of the meeting. This idRefType (puid) indicates which attendee, (from the list of attendees at the event level) are not invited to this particular meeting instance, as specified in /myCalendar/event/recurrence/exception/deletedAttendee (string minOccurs=0 maxOccurs=unbounded). The /myCalendar/event/recurrence/exception/deletedAttachment (string minOccurs=0 maxOccurs=unbounded) is used when the meeting organizer of a recurring meeting may wish to exclude a particular attachment for an instance of the meeting.

The /myCalendar/event/recurrence/exception/attachment (minOccurs=0 maxOccurs=unbounded) specifies the scheme the message contents were encoded in. Examples of this are ‘7bit’, ‘8bit’ and ‘base64’.

The /myCalendar/event/recurrence/exception/attachment/name (string minOccurs=l maxOccurs=1) element contains information about an individual attachment in a mail message. The /myCalendar/event/recurrence/exception/attachment/name/@xml:lang (minOccurs=1maxOccurs=1) required attribute is used to specify an ISO 639 language code or an ISO 3166 country code as described in RFC 1766. The value of this attribute indicates the language type of the content within this element. The /myCalendar/event/recurrence/exception/attachment/name/@dir (string minOccurs=0 maxOccurs=1) optional attribute specifies the default layout direction for the localized string. Valid values are rtl (right to left) and ltr (left to right).

The /myCalendar/event/recurrence/exception/attachment/contentType (string minOccurs=1maxOccurs=1) element contains the content type of the attachment.

The /myCalendar/event/recurrence/exception/attachment/contentTransferEncoding (string minOccurs=1maxOccurs=1) element contains the encoding of the attachment. This information is necessary for decoding the attachment.

The /myCalendar/event/recurrence/exception/attachment/size (unsignedLong minOccurs=1maxOccurs=1) element contains the size of the attachment in bytes.

The /myCalendar/event/recurrence/exception/attachment/attachmentBody (base64Binary minOccurs=1maxOccurs=1) element contains the contents of the attachment.

The /myCalendar/event/recurrence/exception/attendee (minOccurs=0 maxOccurs=unbounded) attendeeType contains the information about an attendee, including the display, email, puid, and the attendee's response.

The /myCalendar/event/recurrence/exception/attendee/name (string minOccurs=0 maxOccurs=1) optional element specifies the name for the enclosing element. The /myCalendar/event/recurrence/exception/attendee/name/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/recurrence/exception/attendee/name/@dir (string minOccurs=0 maxOccurs=1) optional attribute specifies the default layout direction for the localized string. Valid values are rtl (right to left) and ltr (left to right).

The /myCalendar/event/recurrence/exception/attendee/puid (string minOccurs=0 maxOccurs=1) optional element specifies the PUID for the enclosing element.

The /myCalendar/event/recurrence/exception/attendee/email (string minOccurs=0 maxOccurs=1) optional name specifies an e-mail address for the enclosing element.

The /myCalendar/event/recurrence/exception/attendee/inviteType (string minOccurs=1 maxOccurs=1) is used by the meeting organizer to define the kind of invitee {required, optional, resource}.

The /myCalendar/event/recurrence/exception/attendee/responseTime (dateTime minOccurs=0 maxOccurs=1) is for the reply time. The reply time on each attendee is set to the current time (Now) when the organizer sends a meeting invitation. When the attendee responds, they always update their responseTime. When the organizer receives responses, they will honor only those that have a higher responseTime than what s/he maintains in his/her own copy of the event for each attendee. While processing the response, the organizer will update their responseTime. This guarantees that the organizer honors only the most recent response from the attendee. This is stored in UTC.

The /myCalendar/event/recurrence/exception/attendee/responseType (string minOccurs=0 maxOccurs=1) accept status indicates the valid types of responses that an attendee can reply with {accept, decline, tentative, counterpropose}. The absence of this field indicates that no response has been recorded (either the invitation has not been sent, or that a reply has not been received).

The /myCalendar/event/recurrence/exception/attendee/counterProposeStartTime (dateTime minOccurs=0 maxOccurs=1) is like other counter proposal data. Thus, If responseType=[counterPropose], then either the {startTime, endTime}, or location, or both can be present. This is the invitee's counterProposal for a new start time for the meeting. This is stored in UTC. The /myCalendar/event/recurrence/exception/attendee/counterProposeEndTime (dateTime minOccurs=0 maxOccurs=1) is for the counter-proposed end time, and if responseType=[counterPropose], then either the {startTime, endTime}, or location, or both can be present. This is the invitee's counterproposal for a new end time for the meeting. This is stored in UTC. The /myCalendar/event/recurrence/exception/attendee/counterProposeLocation (string minOccurs=0 maxOccurs=1) field is for the counter-proposed location. If responseType=[counterPropose], then either the {startTime, endTime}, or location, or both can be present. This is the invitee's counterproposal for a location for the meeting.

The /myCalendar/event/recurrence/exception/attendee/responseBody (string minOccurs=0 maxOccurs=1) provides for an optional message for invitees to include along with the response. The /myCalendar/event/recurrence/exception/attendee/responseBody/@xml:lang (minOccurs=1 maxOccurs=1) required attribute is used to specify an ISO 639 language code or an ISO 3166 country code as described in RFC 1766. The value of this attribute indicates the language type of the content within this element. The /myCalendar/event/recurrence/exception/attendee/responseBody/@dir (string minOccurs=0 maxOccurs=1) optional attribute specifies the base direction of directionally neutral text. Possible values include rtl (right to left) and ltr (left to right).

The /myCalendar/event/recurrence/exception/attendee/{any} (minOccurs=0 maxOccurs=unbounded) field provides extensibility.

The /myCalendar/event/recurrence/exception/reminder (minOccurs=0 maxOccurs=1) are the properties of the reminder that may be modified. If there is no reminder subschema in the event body, exception reminders are ignored.

The /myCalendar/event/recurrence/exception/reminder/set (boolean minOccurs=0 maxOccurs=1), /myCalendar/event/recurrence/exception/reminder/offset (int minOccurs=0 maxOccurs=1) and /myCalendar/event/recurrence/exception/reminder/interruptability (int minOccurs=0 maxOccurs=1), are generally as described above, however note that these fields are for exceptions.

The /myCalendar/event/recurrence/exception/{any} (minOccurs=0 maxOccurs=unbounded) provides for additional properties of the myCalendar/BaseEventType schema.

The /myCalendar/event/recurrence/{any} (minOccurs=0 maxOccurs=unbounded) provides for additional recurrence rule elements.

The /myCalendar/subscription (minOccurs=0 maxOccurs=unbounded) element defines a subscription node as described above in the subscription section.

The myCalendar content document include a subscription node that essentially takes action when items change, such as to propagate information about the change to other services.

The /myCalendar/subscription (minOccurs=0 maxOccurs=unbounded) element defines a subscription node that is designed to be an xdb:blue node which when placed in a content document causes a subscription to be registered, (wherein as used herein, the string “myCalendar” referred to in this section can be replaced by an appropriate service name, e.g., “myApplicationSettings” or “myCalendar” or “mywallet” and so forth). A subscription contains a trigger element which selects a scope of coverage. When items that are under this scope of coverage change, a subscriptionResponse message is generated and sent to the specified destination address.

The /myCalendar/subscription/@changeNumber (minOccurs=0 maxOccurs=1) changeNumber attribute is designed to facilitate caching of the element and its descendants. This attribute is assigned to this element by the .NET My Services system, and the attribute is read-only to applications; attempts to write this attribute are silently ignored. The /myCalendar/subscription/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /myCalendar/subscription/@creator (string minOccurs=0 maxOccurs=1) attribute identifies the creator in terms of userId, appId, and platformId of the node. The /myCalendar/subscription/trigger (minOccurs=1maxOccurs=1) includes the /myCalendar/subscription/trigger/@select (string minOccurs=0 maxOccurs=1) item, which specifies an XPATH expression that specifies the nodes that are to be selected and watched for changes. The selection may only select xdb:blue nodes, as described above. A s changes in this node set occur, they trigger the generation of a subscription message. These messages are then sent to the SOAP receiver listed in the “to” element.

The /myCalendar/subscription/trigger/@mode (string minOccurs=0 maxOccurs=1) attribute specifies whether or not the content of the changes that triggered the subscription are delivered in the subscription message, or if the message simply indicates that something changed under the trigger. The attribute may comprise includeData, namely that the data that changed and caused the subscription to trigger is included in the subscription message. Note that deleted nodes are specified by their id, not by value. Alternatively the attribute may comprise excludeData, whereby the data that changed, causing the subscription to trigger, is not included in the subscription message.

The /myCalendar/subscription/trigger/@baseChangeNumber (minOccurs=0 maxOccurs=1) attribute specifies the changeNumber value that the trigger is relative to. All changes between the specified change number, and the current state of the document relative to the selection are transmitted as subscription messages. This allows a client application to establish a subscription relative to some baseline. As in changeQuery, if the baseChangeNumber is way out of date relative to the current state of the document, and the service can not supply the changes in the subscription message, the subscription insert is rejected. A value of zero (0) means that the current values of the selected nodes are transmitted in the subscription message.

The /myCalendar/subscription/expiresAt (dateTime minOccurs=0 maxOccurs=1) optional element specifies an absolute time after which the subscription is no longer active. The subscription node is automatically removed when the subscription expires. If this element is missing, the subscription does not expire. The /myCalendar/subscription/context (minOccurs=1maxOccurs=1) element returns the context element from the original subscription. Applications should use this element to correlate the subscription response with one of their subscriptions.

The /myCalendar/subscription/context/@uri (anyURI minOccurs=0 maxOccurs=1) attribute specifies the URI value chosen by the subscriber that is associated with this subscription. The /myCalendar/subscription/context/{any} (minOccurs=0 maxOccurs=unbounded) including the /myCalendar/subscription/to (anyURI minOccurs=1 maxOccurs=1) attribute specifies the location that is to receive the subscription message. The value of this element may be hs:myAlerts, whereby this URI indicates that generated subscription messages are to be delivered inside the body of a notification and delivered to the default .NET Alerts service of the creator. Alternatively, the value may be protocol://service, whereby this URI indicates that generated subscription messages are delivered to the specified service at the domain of the creator's platformId. For example, a platformId indicating microsoft.com, and a value in this element of http://subscriptionResponse would cause delivery of the subscription message to http://subscriptionResponse.microsoft.com. If this value is not specified, then the subscription message is delivered as a notification to the “creator's”.NET Alerts service. The /myCalendar/{any} (minOccurs=0 maxOccurs=unbounded) field allows for extensibility.

MyCalendar/System

The system document is a global document for each service, having content and meaning that is independent of the puid used to address the service. The document is read only to all users. Each system document contains a set of base items common to each of the NET My Services described herein, and is optionally extended by each service to include service-specific global information. The following schema outline illustrates the layout and meaning of the information found in the myCalendar system document:

TABLE
/*actual service name*/ system

<sys:system changeNumber=“...” instanceId=“...”

xmlns:hs=“http://schemas.microsoft.com/hs/2001/10/core”
xmlns:sys=“http://schemas.microsoft.com/hs/2001/10The/*actual service name*/system” >_{1..1}
<hs:systemVersion changeNumber=“...” id=“...” creator=“...” >_{1..1}

<hs:version majorVersion=“...” minorVersion=“...” buildNumber=“...” qfe=“...” >_{1..1}

<hs:productReleaseName>_{1..1}</hs:productReleaseName>
<hs:productImplementationName>_{1..1}</hs:productImplementationName>

</hs:version>
<hs:buildDate>_{1..1}</hs:buildDate>
<hs:buildDetails machine=“...” branch=“...” type=“...” official=“...” >_{1..1}</hs:buildDetails>

</hs:systemVersion>
<hs:roleMap changeNumber=“...” id=“...” creator=“...” >_{1..1}

<hs:scope id=“...” >_{0..unbounded}

<hs:name xml:lang=“...” dir=“...” >_{0..unbounded}</hs:name>
<hs:shape base=“...” >_{1..1}

<hs:include select=“...” >_{0..unbounded}</hs:include>
<hs:exclude select=“...” >_{0..unbounded}</hs:exclude>

</hs:shape>

</hs:scope>
<hs:roleTemplate name=“...” priority=“...” >_{0..unbounded}

<hs:fullDescription xml:lang=“...” dir=“...” >_{0..1}</hs:fullDescription>
<hs:method name=“...” scopeRef=“...” >_{0..unbounded}</hs:method>

</hs:roleTemplate>

</hs:roleMap>
<hs:methodMap changeNumber=“...” id=“...” creator=“...” >_{1..1}

<hs:method name=“...” >_{0..unbounded}{any}</hs:method>

</hs:methodMap>
<hs:schemaMap changeNumber=“...” id=“...” creator=“...” >_{1..1}

<hs:schema namespace=“...” schemaLocation=“...” alias=“...” >_{0..unbounded}{any}</hs:schema>

</hs:schemaMap>
<hs:wsdlMap changeNumber=“...” id=“...” creator=“...” >_{1..1}

<hs:wsdl wsdlLocation=“...” >_{0..unbounded}{any}</hs:wsdl>
<hs:disco discoLocation=“...” >_{0..unbounded}{any}</hs:disco>
<hs:wsil wsilLocation=“...” >_{0..unbounded}{any}</hs:wsil>

</hs:wsdlMap>

</any>
</sys:system>

The meaning of the attributes and elements shown in the preceding sample document outline follow, beginning with /system (minOccurs=1maxOccurs=1), the element that encapsulates a system document common to the various services. Although each service has its own system document, the common system document attributes and elements are described once, for purposes of simplicity, with service-specific system document attributes and elements specified for each service, below. The /system/@changeNumber (minOccurs=0 maxOccurs=1) attribute is designed to facilitate caching of the element and its descendants. This attribute is assigned to this element by the .NET My Services system. The attribute is read-only to applications. Attempts to write this attribute are silently ignored.

The /system/@instanceId (string minOccurs=0 maxOccurs=1) attribute is a unique identifier typically assigned to the root element of a service. It is a read-only element and assigned by the .NET My Services system when a user is provisioned for a particular service.

The /system/systemVersion (minOccurs=1maxOccurs=1) element defines version information describing this instance of the .NET MyServices service. The /systemVersion/@changeNumber (minOccurs=0 maxOccurs=1) changeNumber attribute is designed to facilitate caching of the element and its descendants. This attribute is assigned to this element by the .NET My Services system. The attribute is read-only to applications; attempts to write this attribute are silently ignored, (e.g., without generating an error).

The /system/systemVersion/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /system/systemVersion/@creator (string minOccurs=0 maxOccurs=1) attribute identifies the creator in terms of userId, appId, and platformId of the node. The /system/systemVersion/version (minOccurs=1maxOccurs=1) element defines major, minor, and build number version information. The /system/systemVersion/version/@majorVersion (string minOccurs=0 maxOccurs=1) attribute specifies the major version number of the .NET MyServices service.

The /system/systemVersion/version/@minorVersion (string minOccurs=0 maxOccurs=1) attribute specifies the minor version number of the .NET MyServices service. The /system/systemVersion/version/@buildNumber (string minOccurs=0 maxOccurs=1) attribute specifies the buildNumber of the .NET MyServices service. The /system/systemVersion/version/@qfe (string minOccurs=0 maxOccurs=1) attribute specifies the qfe version number of the .NET MyServices service. The /system/systemVersion/version/productReleaseName (string minOccurs=1 maxOccurs=1) element defines the major product release string (as in .NET My Services Beta 1, and so on). The /system/systemVersion/version/productImplementationName (anyURI minOccurs=1 maxOccurs=1) element defines the class of the service to differentiate between different implementations.

The /system/systemVersion/buildDate (dateTime minOccurs=1 maxOccurs=1) element defines the date and time that the .NET My Services system was built. The time is in UTC (Z relative) form. The /systemVersion/buildDetails (minOccurs=1 maxOccurs=1) element defines details of the build including the machine that generated the build, the branch id of the software that contributed to the build, the type of build (chk/fre), and if the build was generated by an official build release process.

The /system/systemVersion/buildDetails/@machine (string minOccurs=0 maxOccurs=1) attribute specifies the machine that generated the build. The system/systemVersion/buildDetails/@branch (string minOccurs=0 maxOccurs=1) attribute specifies the software branch id for the source code that contributed to this build. The /system/systemVersion/buildDetails/@type (string minOccurs=0 maxOccurs=1) attribute specifies the type of build. A value of chk indicates that this is a checked or debug build. A value of fre indicates that this is a retail build. The /system/systemVersion/buildDetails/@official (string minOccurs=0 maxOccurs=1) attribute indicates that the build was produced by an official build process (value of yes), or an unofficial process (value of no).

The /system/roleMap (minOccurs=1maxOccurs=1) element encapsulates all the elements that make up a roleMap, which include document class relative roleTemplate, priority, name, method, and per-method scope. An individual roleTemplate defines the maximum scope of information, and the allowable methods used to access that information for each request mapped into the template. The /system/roleMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored. The /system/roleMap/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /system/roleMap/@creator (string minOccurs=0 maxOccurs=1) attribute identifies the creator in terms of userId, appId, and platformId of the node. The /system/roleMap/scope (minOccurs=0 maxOccurs=unbounded) element defines a scope which may be referred to by roles within this roleMap to indicate what portions of the document are visible to this role for the specified method.

The /system/roleMap/scope/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The /system/roleMap/scope/name (string minOccurs=0 maxOccurs=unbounded) node includes the /system/roleMap/scope/name/@xml:lang (minOccurs=1maxOccurs=1) required attribute, which is used to specify an ISO 639 language code or an ISO 3166 country code as described in RFC 1766. The value of this attribute indicates the language type of the content within this element. The /system/roleMap/scope/name/@dir (string minOccurs=0 maxOccurs=1) optional attribute specifies the default layout direction for the localized string. Valid values are rtl (right to left), and ltr (left to right).

The /system/roleMap/scope/shape (minOccurs=1maxOccurs=1) comprises a shape that defines the node set that is visible through the document when operating through this shape element. The /system/roleMap/scope/shape/@base (string minOccurs=0 maxOccurs=1) attribute specifies the initial set of nodes visible through the shape. A value of t indicates that the shape is initialized to include all possible nodes relative to the shape that is currently in effect. For instance, each role defines a scope containing a shape. When defining a shape for a role, the value t indicates all possible nodes available in the specified document for this role. When defining a shape in an ACL entry, a value of t means all of the nodes visible in the shape for the computed role. When using a shape in a data language (e.g., query, insert, replace and so on) operation, a value of t indicates all of the possible nodes selected by the data language operation (relative to the ACL shape which itself is relative to the role's shape). The value nil indicates the opposite of t, which is the empty node set. Nodes from this set may then be included into the shape.

The /system/roleMap/scope/shape/include (minOccurs=0 maxOccurs=unbounded) element specifies the set of nodes that should be included into the shape relative to the possible set of nodes indicated by the base attribute. The /system/roleMap/scope/shape/include/@select (string minOccurs=0 maxOccurs=1) item specifies an XPATH expression that selects a set of nodes relative to the externally established context. The expression can never travel outside the node-set established by this externally established current context. The expression may match zero or more nodes, and the operation manipulates all selected nodes. The minOccurs and maxOccurs attributes are optional and place restrictions and limitations on the number of nodes selected.

The /system/roleMap/scope/shape/exclude (minOccurs=0 maxOccurs=unbounded) element specifies the set of nodes that should be excluded from the shape relative to the possible set of nodes indicated by the base attribute. The /system/roleMap/scope/shape/exclude/@select (string minOccurs=0 maxOccurs=1) item specifies an XPATH expression that selects a set of nodes relative to the externally established context. The expression can never travel outside the node-set established by this externally established current context. The expression may match zero (0) or more nodes, and the operation manipulates all selected nodes. The minOccurs and maxOccurs attributes are optional and place restrictions and limitations on the number of nodes selected. The /system/roleMap/roleTemplate (minOccurs=0 maxOccurs=unbounded) element encapsulates the definition of a role. The attribute set for this element includes the document class that this roleTemplate refers to, the name of the roleTemplate, and the priority of the roleTemplate.

The /system/roleMap/roleTemplate/@name (string minOccurs=0 maxOccurs=1) element specifies the name of the role. The /system/roleMap/roleTemplate/@priority (int minOccurs=0 maxOccurs=1) element specifies the priority of the roleTemplate which is used to select that actual roleTemplate when the role evaluation determines that the subject maps to multiple roleTemplates.

The /system/roleMap/roleTemplate/fullDescription (string minOccurs=0 maxOccurs=1) element contains a description of this role template which specifies the capabilities a caller will have when accessing information through this role. The /system/roleMap/roleTemplate/fullDescription/®xml:lang (minOccurs=1 maxOccurs=1) required attribute is used to specify an ISO 639 language code or an ISO 3166 country code as described in RFC 1766. The value of this attribute indicates the language type of the content within this element. The /system/roleMap/roleTemplate/fullDescription/@dir (string minOccurs=0 maxOccurs=1) optional attribute specifies the default layout direction for the localized string. Valid values are rtl (right to left), and ltr (left to right).

The /system/roleMap/roleTemplate/method (minOccurs=0 maxOccurs=unbounded) element specifies the methods available within this roleTemplate by name, and by scope. When a subject maps to a roleTemplate, the method in the request must match one of these elements for the message to continue to flow. If the method exists, the data available to the method is a function of the scope referenced by this method combined with an optional scope referenced by the role defined in the roleList.

The /system/roleMap/roleTemplate/method/@name (string minOccurs=0 maxOccurs=1) element specifies the name of the method. The /system/roleMap/roleTemplate/method/@scopeRef (string minOccurs=0 maxOccurs=1) attribute specifies the scope within this document that is in effect for this method. The /system/methodMap (minOccurs=1 maxOccurs=1) element defines the methodMap. While in most cases, the roleMap section contains a definitive list of methods, these methods are likely to be scattered about the roleMap in various templates. This section contains the definitive non-duplicated list of methods available within the service.

The /system/methodMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored.

The /system/methodMap/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The /system/methodMap/@creator (string minOccurs=0 maxOccurs=1) attribute identifies the creator in terms of userId, appId, and platformId of the node.

The /system/methodMap/method (minOccurs=0 maxOccurs=unbounded) element defines a method that is available within this service. The /system/methodMap/method/@name (string minOccurs=0 maxOccurs=1) attribute specifies the name of a method available within the service. The /system/methodMap/method/{any} (minOccurs=0 maxOccurs=unbounded) provides for extensibility. The /system/schemaMap (minOccurs=1maxOccurs=1) element defines the various schema's that define the data structures and shape of information managed by this service. Each schema is defined by its namespace URI, its location, and a preferred namespace alias.

The /system/schemaMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored.

The /system/schemaMap/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /system/schemaMap/@creator (string minOccurs=0 maxOccurs=1) attribute identifies the creator in terms of userId, appId, and platformId of the node. The /system/schemaMap/schema (minOccurs=0 maxOccurs=unbounded) element defines a schema which defines data-structures and the shape of information managed by this service. Multiple schema elements exist for each service, once for each logical grouping of information exposed by the service. The /system/schemaMap/schema/@namespace (anyURI minOccurs=0 maxOccurs=1) attribute specifies the namespace URI of this schema. The /system/schemaMap/schema/@schemaLocation (anyURI minOccurs=0 maxOccurs=1) attribute specifies the location (in the form of a URI) of the resource containing schema. When a schema is reachable through a variety of URIs, one schema element will exist for each location.

The /system/schemaMap/schema/@alias (string minOccurs=0 maxOccurs=1) attribute specifies the preferred alias that should be used if possible when manipulating information covered by this schema in the context of this service. The /system/schemaMap/schema/{any} (minOccurs=0 maxOccurs=unbounded) provides for extensibility. The /system/wsdlMap (minOccurs=1maxOccurs=1) element defines the wsdlMap for this service. This map includes the location of WSDL documents, DISCO documents, and WSIL documents for this web service. These documents are used by applications to understand the format of messages that may be sent to the various services. The /system/wsdlMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored.

The /system/wsdlMap/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The /system/wsdlMap/@creator (string minOccurs=0 maxOccurs=1) attribute identifies the creator in terms of userId, appId, and platformId of the node.

The /system/wsdlMap/wsdl (minOccurs=0 maxOccurs=unbounded) element is used to specify the location of a WSDL file for this service. Multiple entries may exist pointing to the same file hosted in multiple locations, or to variations on the content within the WSDL files.

The /system/wsdlMap/wsdl/@wsdlLocation (anyURI minOccurs=0 maxOccurs=1) attribute is a URI that specifies the location of the WSDL file. The /system/wsdlMap/wsd/{any} (minOccurs=0 maxOccurs=unbounded) provides for extensibility.

The /system/wsdlMap/disco (minOccurs=0 maxOccurs=unbounded) element is used to specify the location of a DISCO (web-services discovery) file for this service. Multiple entries may exist pointing to the same file hosted in multiple locations, or to variations on the content within the DISCO files. The /system/wsdlMap/disco/@discoLocation (anyURI minOccurs=0 maxOccurs=1) attribute is a URI that specifies the location of the DISCO file. The /system/wsdlMap/disco/{any} (minOccurs=0 maxOccurs=unbounded) provides extensibility. The /system/wsdlMap/wsil (minOccurs=0 maxOccurs=unbounded) element is used to specify the location of a WSIL file for this service. Multiple entries may exist pointing to the same file hosted in multiple locations, or to variations on the content within the WSIL files. The /system/wsdlMap/wsil/®wsilLocation (anyURI minOccurs=0 maxOccurs=1) attribute is a URI that specifies the location of the WSIL file. The /system/wsdlMap/wsil/{any} (minOccurs=0 maxOccurs=unbounded) provides extensibility.

myCalendar/Domain Specific Methods

In addition to the standard methods, the myCalendar service supports the domain-specific methods, getCalendarDays, getFreeBusyDays, getQuickView, sendMeeting, respond and updateReminder.

The myCalendar/getCalendarDaysRequest is a calendar date range event generator. This method is accessed using a request message, and in response may generate a response message or a SOAP Fault message. The following sample document fragments illustrate the structure and meaning of the elements and attributes in the request and response messages. The following is a request message XML fragment for getCalendarDays; it takes a startDate and an endDate to define the duration over which calendar events are returned:

<m:getCalendarDaysRequest

xmlns:m=“http://schemas.microsoft.com/hs/2001/10/myCalendar”
xmlns:hs=“http://sehemas.microsoft.com/hs/2001/10/core”>_{1..1}
<m:calendarType>_{0..1}</m:calendarType>
<m:startTime>_{1..1}</m:startTime>
<m:endTime>_{1..1}</m:endTime>
<m:removeRecurrence>_{0..1}</m:removeRecurrence>

</m:getCalendarDaysRequest>

The /getCalendarDaysRequest (minOccurs=1maxOccurs=1) function returns an XML stream of calendar appointments/events between two dates. Recurrence rules are expanded to create individual calendar items. Holidays are represented as all-day events, and these are returned as well. The getCalendarDays method is a query-retrieval of data, but the behavior expands recurrence rules into individual (aliased) events, adds in holidays, and adds regular events and sorts the entire list based on start time. No merging of event blocks occurs. Any object which overlaps the method parameters {startTime, endTime} will be returned. For example, if an event crosses midnight and the startTime is 12am, that event will be returned. In case the startDate, endDate is one day, the events are sorted in the following order: holidays, all-day events, and regular events (based on startTime). The {startTime, endTime] time window can define any interval: 24 hr period, week, month, or any other user-defined period.

The getCalendarDays method returns the calendaring info of any puid that is specified for which the caller has sufficient privileges. The user's own puid must be specified to retrieve their own information. The getCalendarDays method may be used to retrieve multiple calendar data from other users using <h:key instance=“0” cluster=“0” puid=“xyz”/> in the SOAP headers provided that puid “xyz” is provisioned on the .NET Calendar server, and provided that the user has been granted access in puid “xyz”'s roleList.

The /getCalendarDaysRequest/calendarType (string minOccurs=0 maxOccurs=1) optionally specifies the calendar type to return, as set forth in the calendar-types table above. The system defaults to Gregorian if not specified.

The /getCalendarDaysRequest/startTime (dateTime minOccurs=1maxOccurs=1) specifies the starting time window of calendar objects to retrieve. This dateTime also contains the timeZone to retrieve the calendar information in.

The /getCalendarDaysRequest/endTime (dateTime minOccurs=1maxOccurs=1) field contains the ending time window to retrieve calendar objects. This dateTime also contains the timeZone to retrieve the calendar information in, and needs to be the same timeZone as startTime.

Normally, the recurrence sub-schema, (minus modifiedException and minus deletedExceptionDate components) is returned with each instance of a recurring event, like “recurring-instance” and “recurring-exception”. This allows clients to properly render the recurrence pattern without having to explicitly query the recurring-master. However, because it is heavy on bandwidth, .NET Calendar includes the option to not return this data, via /getCalendarDaysRequest/removeRecurrence (boolean minOccurs=0 maxOccurs=1).

Upon successful completion of the above method, a response message, myCalendar/getCalendarDaysResponse, is generated. In the response, calendar events are returned with their recurrence rules expanded into first-class events. These events have aliased PUIDs, logically as part of the same event. Recurrence information is stripped from the original event. The following is a response schema outline:

<m:getCalendarDaysResponse selectedNodeCount=“...” status=“...”

xmlns:m=“http://schemas.microsoft.com/hs/2001/10/myCalendar”
xmlns:hs=“http://schemas.microsoft.com/hs/2001/10/core”>_{1..1}
<m:event instanceType=“...” calendarType=“...” advanceHijriValue=“...” changeNumber=“...”

id=“...” creator=“...”>_{0..unbounded}

<m:body changeNumber=“...”>_{1..1}

<m:cat ref=“...”>_{0..unbounded}</m:cat>
<m:title xml:lang=“...” dir=“...”>_{1.1}</m:title>
<m:fullDescription xml:lang=“...” dir=“...”>_{0..1}</m:fullDescripfion>
<m:location xml:lang=“...” dir=“...”>_{0..1}</m:location>
<m:meetingStatus>_{0..1}</m:meetingStatus>
<m:recurrenceId>_{0..1}</m:recurrenceId>
<m:lastUpdateTime>_{0..1}</m:lastUpdateTime>
<m:startTime>_{1..1}</m:startTime>
<m:endTime>_{1..1}</m:endTime>
<m:allDay>_{0..1}</m:allDay>
<m:floating>_{0..1}</m:floating>
<m:travelTimeTo>_{0..1}</m:travelTimeTo>
<m:travelTimeFrom>_{0..1}</m:travelTimeFrom>
<m:freeBusyStatus>_{0..1}</m:freeBusyStatus>
<m:cuid>_{0..1}</m:cuid>
<m:organizer>_{0..1}

<hs:name xml:lang=“...” dir=“...”>_{0..1}</hs:name>
<hs:puid>_{0..1}</hs:puid>
<hs:email>_{0..1}</hs:email>

</m:organizer>
{any}

</m:body>
<m:attachment>_{0..unbounded}

<m:name xml:lang=“...” dir=“...”>_{1..1}</m:name>
<m:contentType>_{1..1}</m:contentType>
<m:contentTransferEncoding>_{1..1}</m:contentTransferEncoding>
<m:size>_{1..1}</m:size>
<m:attachmentBody>_{1..1}</m:attachmentBody>

</m:attachment>
<m:reminder>_{0..1}

<m:set>_{1..1}</m:set>
<m:to xml:lang=“...” dir=“...”>_{1..1}</m:to>
<m:offset>_{1..1}</m:offset>
<m:interruptability>_{0..1}</m:interruptability>
<m:lastSentTime>_{1..1}</m:lastSentTime>
<m:nextTriggerTime>_{1..1}</m:nextTriggerTime>

</m:reminder>
<m:attendee>_{0..unbounded}

<hs:name xml:lang=“...” dir=“...”>_{0..1}</hs:name>
<hs:puid>_{0..1}</hs:puid>
<hs:email>_{0..1}</hs:email>
<m:inviteType>_{1..1}</m:inviteType>
<m:responseTime>_{0..1}</m:responseTime>
<m:responseType>_{0..1}</m:responseType>
<m:counterProposeStartTime>_{0..1}</m:counterProposeStartTime>
<m:counterProposeEndTime>_{0..1}</m:counterProposeEndTime>
<m:counterProposeLocation>_{0..1}</m:counterproposeLocation>
<m:responseBody xml:lang=“...” dir=“...”>_{0..1}</m:responseBody>
{any}

</m:attendee>
<m:recurrence>_{0..1}

<m:rule>_{1..1}

<m:creationDate>_{1..1}</m:creationDate>
<m:firstDayOfWeek>_{1..1}</m:firstDayOfweek>
<m:tzid>_{0..1}</m:tzid>
<m:isLeapYear>_{0..1}</m:isLeapYear>
<m:leapMonthValue>_{0..1}</m:leapMonthValue>
<m:repeat>_{1..1}

<m:daily dayFrequency=“...”>_{0..1}</m:daily>
<m:weekly su=“...” mo=“...” tu=“...” we=“...” th=“...” fr=“...” sa=“...”

weekFrequency=“...”>_{0..1}</m:weekly>

<m:monthlyByDay su=“...” mo=“...” tu“...” we=“...” th=“...” fr=“...” sa=“...”

monthFrequency=“...” weekdayOfMonth=“...”>_{0..1}</m:monthlyByDay>

<m:monthly monthFrequency=“...” day=“...” forceExact=“...”>_{0..1}</m:monthly>
<m:yearlyByDay su=“...” mo=“...” tu=“...” we=“...” th=“...” fr=“...” sa=“...”

yearFrequency=“...” weekdayOfMonth=“...” month=“...”>_{0..1}</m:yearlyByDay>

<m:yearly yearFrequency=“...” month=“...” day=“...” forceExact=“...”>_{0..1}</m:yearly>
{any}

</m:repeat>
<m:windowEnd>_{0..1}</m:windowEnd>
<m:repeatForever>_{0..1}</m:repeatForever>
<m:repeatInstances>_{0..1}</m:repeatInstances>

</m:rule>

</m:recurrence>

</m:event>

</m:getCalendarDaysResponse>

The /getCalendarDaysResponse (minOccurs=1maxOccurs=1) response XML blob format, comprises the base event type minus recurrence. The /getCalendarDaysResponse/@selectedNodeCount (int minOccurs=0 maxOccurs=1) This attribute is used to return the number of selected nodes, selected by the corresponding data language operation. The /getCalendarDaysResponse/@status (string minOccurs=l maxOccurs=1) attribute indicates the status of the method.

If the status is success, the corresponding method was completed successfully. If the status is failure, the corresponding method was not completed successfully. If the status is rollback, the method failed, but was rolled back to its pre-updateBlock status. If the status is notAttempted, the corresponding method was not attempted. This occurs when a previous operation failed.

The /getCalendarDaysResponse/event (minOccurs=0 maxOccurs=unbounded), if present, may have a /getCalendarDaysResponse/event/@instanceType (string minOccurs=0 maxOccurs=1) field which distinguishes between a single instance of an event or an instance of a recurring event. The recurring instance is a modified exception if eventBody/recurrenceId is present: single, recurring-master, recurring-instance, recurring-exception. The /getCalendarDaysResponse/event/@calendarType (string minOccurs=0 maxOccurs=1) field identifies an enumeration which determines the kind of calendar event this is, as set forth in the above calendar type table.

The /getCalendarDaysResponse/event/@advanceHijriValue (int minOccurs=0 maxOccurs=1) field is required for Hijri calendar support. @advanceHijriValue ranges from {−3, −2, −1, 1, 2, 3} and is added to the current date, but the day of the week stays the same. For example, if today is the 24th and @advanceHijriValue is set to be +2, then the user sees the date as being the 26th. Typically @advanceHijriValue is +/−1, and this suffices in most cases. Theoretically it can be any number, but the worst case scenario is +/−3.

The /getCalendarDaysResponse/event/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /getCalendarDaysResponse/event/@id (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /getCalendarDaysResponse/event/@creator (minOccurs=1 maxOccurs=1) attribute identifies the creator in terms of userId, appId, and platformId of the node.

The /getCalendarDaysResponse/event/body (minOccurs=1 maxOccurs=1) includes the /getCalendarDaysResponse/event/body/@changeNumber (minOccurs=1 maxOccurs=1) changeNumber attribute, which is designed to facilitate caching of the element and its descendants. This attribute is assigned to this element by the .NET My Services system. The attribute is read only to applications. Attempts to write this attribute are silently ignored.

The /getCalendarDaysResponse/event/body/cat (minOccurs=0 maxOccurs=unbounded) element is used to categorize the element that contains it by referencing either a global category definition (in either the .NET Categories service system document or an external resource containing category definitions), or by referencing an identity-centered category definition in the content document of the .NET Categories service for a particular PUID.

The /getCalendarDaysResponse/event/body/cat/@ref (anyURI minOccurs=1 maxOccurs=1) attribute references a category definition (catDef) element using the rules outlined in the .NET Categories section, described above.

The /getCalendarDaysResponse/event/body/title (string minOccurs=1maxOccurs=1) includes the /getCalendarDaysResponse/event/body/title/@xml:lang (minOccurs=1 maxOccurs=1) required attribute is used to specify an ISO 639 language code or an ISO 3166 country code as described in RFC 1766. The value of this attribute indicates the language type of the content within this element. The /getCalendarDaysResponse/event/body/title/@dir (string minOccurs=0 maxOccurs=1) optional attribute specifies the default layout direction for the localized string. Valid values are rtl (right to left) and ltr (left to right).

The /getCalendarDaysResponse/event/body/fullDescription (string minOccurs=0 maxOccurs=1) element contains a free form, full description of the event. The /getCalendarDaysResponse/event/body/fullDescription/@xml:lang (minOccurs=1 maxOccurs=1) required attribute is used to specify an ISO 639 language code or an ISO 3166 country code as described in RFC 1766. The value of this attribute indicates the language type of the content within this element. The /getCalendarDaysResponse/event/body/fullDescription/@dir (string minOccurs=0 maxOccurs=1) optional attribute specifies the base direction of directionally neutral text. Possible values include rtl (right to left) and ltr (left to right).

The /getCalendarDaysResponse/event/body/location (string minOccurs=0 maxOccurs=1) optional element contains the event's location. The /getCalendarDaysResponse/event/body/location/@xml:lang (minOccurs=1 maxOccurs=1) required attribute is used to specify an ISO 639 language code or an ISO 3166 country code as described in RFC 1766. The value of this attribute indicates the language type of the content within this element. The /getCalendarDaysResponse/event/body/location/@dir (string minOccurs=0 maxOccurs=1) optional attribute specifies the default layout direction for the localized string. Valid values are rtl (right to left) and ltr (left to right).

The /getCalendarDaysResponse/event/body/meetingStatus (string minOccurs=0 maxOccurs=1) tracks the status of this meeting {not-sent, sent, cancelled}. A regular appointment will not have this element. If <meetingStatus> exists, this event should be rendered as a meeting, not as an appointment.

The /getCalendarDaysResponse/event/body/recurrenceId (dateTime minOccurs=0 maxOccurs=1) recurrence id indicates the original start time of an occurrence of a recurring master appointment. It is required to identify what instance an exception is modifying, since users are allowed to change the start time on the orphan. The recurrenceId method is stored in UTC. It does not appear in the master schema, except in the specific case that an attendee is invited to an instance of a recurring event. Otherwise, <recurrenceId> is usually only a part of getCalendarDays.

The /getCalendarDaysResponse/event/body/lastUpdateTime (dateTime minOccurs=0 maxOccurs=1) field is updated by the organizer whenever s/he creates and sends a new meeting request. This helps the attendee to identify which meeting request is the most recent one. It is stored in coordinated universal time (UTC). This property is not modifiable by clients and is assigned by the server on modification and by the sendMeetingRequest.

The /getCalendarDaysResponse/event/body/startTime (dateTime minOccurs=1 maxOccurs=1) startTime method defines the start time of the event. An all-day event by convention starts at 12:00:00 AM of the day of the event. This is stored in UTC. Maximum range is Jan. 1, 1753 to December 31, 9999 to an accuracy of 3.33 milliseconds. If this event is a recurring event, <startTime> defines the dateTime when the recurrence window starts. The recurring master does not have to be an instance of the recurring event itself. An event in March set to recur every April will only appear in April.

The /getCalendarDaysResponse/event/body/endTime (dateTime minOccurs=l maxOccurs=1) endTime method defines the end time of the event. An all-day event by convention ends at 11:59:59 PM of the ending day. This is stored in UTC. Maximum range is Jan. 1, 1753 to December 31, 9999 to an accuracy of 3.33 milliseconds. The duration of the event is inferred from endTime−startTime.

The /getCalendarDaysResponse/event/body/allDay (boolean minOccurs=0 maxOccurs=1) element indicates a regular event by being false or being absent. Otherwise, this attribute indicates that the event is an all-day event. All day events may span multiple days. By convention, all day events start at 12:00:00 am of the day of startTime, regardless of what time it actually is, and it will end at 11:59:59 pm of the endTime date. In other words, if the allDay element is present and has value=true, .NET Calendar will ignore the actual times of the events and consider only the date part of the field.

The allDay tag is meant to operate as a hint to UI renders to display specialized icons indicating an all-day event. allDay events are distinguishable between 24-hr events starting at 12am. In the case of a meeting request, an allDay event will not appear in the local user's time zone, but rather in the organizer's time zone.

The /getCalendarDaysResponse/event/body/floating (boolean minOccurs=0 maxOccurs=1) floating attribute indicates that this event is to occur in the current local time zone no matter what time zone the system is currently in (that is, it floats). For example, holidays are floating events. As another example, it may be useful to schedule medication regardless of an actual time zone, whereby a floating attribute is used with such an event. Floating values are stored as-is: no time-zone translations are needed to convert them to UTC or any local time zone.

The /getCalendarDaysResponse/event/body/travelTimeTo (int minOccurs=0 maxOccurs=1) field contains the amount of time (in minutes) that it takes to travel to the meeting location. The /getCalendarDaysResponse/event/body/travelTimeFrom (int minOccurs=0 maxOccurs=1) field contains the amount of time (in minutes) that it takes to return from the meeting location. These optional elements show in free/busy calculations.

The /getCalendarDaysResponse/event/body/freeBusyStatus (string minOccurs=0 maxOccurs=1) optional element annotates the freeBusy behavior of this event. Events by default appear as “busy”. The user may explicitly define this event to be annotated by setting .NET Calendar values to free, tentative, busy or away.

The /getCalendarDaysResponse/event/body/cuid (string minOccurs=0 maxOccurs=1) cuid (CorrelationUID) links an organizer's event to an attendee's event. It identifies which response from an attendee is for which request from an organizer, and which meeting request update from the organizer is for which previously accepted meeting by the attendee. The “cuid” is the same on both the attendee's and the organizer's copy of the appointment. It is also identical on the exception and the recurring master. This value is assigned by the .NET Calendar server and is non-modifiable.

The /getCalendarDaysResponse/event/body/organizer (minOccurs=0 maxOccurs=1) field contains the email address of the event organizer. The /getCalendarDaysResponse/event/body/organizer/name (string minOccurs=0 maxOccurs=1) optional element specifies the name for the enclosing element. The /getCalendarDaysResponse/event/body/organizer/name/@xml:lang (minOccurs=1 maxOccurs=1) required attribute is used to specify an ISO 639 language code or an ISO 3166 country code as described in RFC 1766. The value of this attribute indicates the language type of the content within this element. The /getCalendarDaysResponse/event/body/organizer/name/@dir (string minOccurs=0 maxOccurs=1) optional attribute specifies the default layout direction for the localized string. Valid values are rtl (right to left) and ltr (left to right).

The /getCalendarDaysResponse/event/body/organizer/puid (string minOccurs=0 maxOccurs=1) optional element specifies the PUID for the enclosing element. The /getCalendarDaysResponse/event/body/organizer/email (string minOccurs=0 maxOccurs=1) optional name specifies an e-mail address for the enclosing element.

The /getCalendarDaysResponse/event/body/{any} (minOccurs=0 maxOccurs=unbounded) provides for additional body elements.

The /getCalendarDaysResponse/event/attendeeEventExtra (minOccurs=0 maxOccurs=1) field contains additional information about an event, found only in an event invitee's schema. The /getCalendarDaysResponse/event/attendeeEventExtra/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /getCalendarDaysResponse/event/attendeeEventExtra/intendedFreeBusy (string minOccurs=0 maxOccurs=1) element is the event organizer's freeBusy information and is thus equal to event/freeBusyStatus. Invitees may overwrite event/freeBusyStatus with a new value, and intendedFreeBusy is intended to store the organizer's original freeBusyStatus.

The /getCalendarDaysResponse/event/attendeeEventExtra/responseTime (dateTime minOccurs=0 maxOccurs=1) field contains the reply time on each attendee is set to the current time (Now) when the organizer sends a meeting invitation. When the attendee responds, they update their responseTime. When the organizer receives responses, they will honor only those that have a higher responseTime than what is maintained in his/her own copy of the event for each attendee. While processing the response, the organizer will update their responseTime. This guarantees that the organizer honors only the most recent response from the attendee. This is stored in UTC.

The /getCalendarDaysResponse/event/attendeeEventExtra/responseType (string minOccurs=0 maxOccurs=1) accept status indicates the valid types of responses that an attendee can reply with {accept, decline, tentative, counterpropose}. The absence of this field indicates that no response has been recorded (either the invitation has not been sent, or that a reply has not been received).

The /getCalendarDaysResponse/event/attendeeEventExtra/counterProposeStartTime (dateTime minOccurs=0 maxOccurs=1) field contains the counter proposal start time information. If responseType=[counterPropose], then either the {startTime, endTime}, or location, or both can be present. This is the invitee's counterproposal for a new start time for the meeting. This is stored in UTC.

The /getCalendarDaysResponse/event/attendeeEventExtra/counterProposeEndTime (dateTime minOccurs=0 maxOccurs=1) field contains the counter proposal end time information. If responseType=[counterPropose], then either the {startTime, endTime}, or location, or both can be present. This is the invitee's counterproposal for a new end time for the meeting. This is stored in UTC.

The /getCalendarDaysResponse/event/attendeeEventExtra/counterProposeLocation (string minOccurs=0 maxOccurs=1) field contains the counter proposal location information. field contains the counter proposal start time information. If responseType=[counterPropose], then either the {startTime, endTime}, or location, or both can be present. This is the invitee's counterProposal for a location for the meeting.

The /getCalendarDaysResponse/event/attendeeEventExtra/responseBody (string minOccurs=0 maxOccurs=1) field contains an optional message for invitees to include along with the response. The /getCalendarDaysResponse/event/attendeeEventExtra/responseBody/@xml:lang (minOccurs=1maxOccurs=1) required attribute is used to specify an ISO 639 language code or an ISO 3166 country code as described in RFC 1766. The value of this attribute indicates the language type of the content within this element. The /getCalendarDaysResponse/event/attendeeEventExtra/responseBody/@dir (string minOccurs=0 maxOccurs=1) optional attribute specifies the base direction of directionally neutral text. Possible values include rtl (right to left) and ltr (left to right). The /getCalendarDaysResponse/event/attendeeEventExtra/delegateResponder (minOccurs=0 maxOccurs=1) field stores information of a delegate who responds on behalf of an invitee. The /getCalendarDaysResponse/event/attendeeEventExtra/delegateResponder/name (string minOccurs=0 maxOccurs=1) optional element specifies the name for the enclosing element. The /getCalendarDaysResponse/event/attendeeEventExtra/delegateResponder/name/@xml:lang (minOccurs=1maxOccurs=1) required attribute is used to specify an ISO 639 language code or an ISO 3166 country code as described in RFC 1766. The value of this attribute indicates the language type of the content within this element. The /getCalendarDaysResponse/event/attendeeEventExtra/delegateResponder/name/@dir (string minOccurs=0 maxOccurs=1) optional attribute specifies the default layout direction for the localized string. Valid values are rtl (right to left) and ltr (left to right).

The /getCalendarDaysResponse/event/attendeeEventExtra/delegateResponder/puid (string minOccurs=0 maxOccurs=1) optional element specifies the PUID for the enclosing element. The /getCalendarDaysResponse/event/attendeeEventExtra/delegateResponder/email (string minOccurs=0 maxOccurs=1) optional name specifies an e-mail address for the enclosing element. The /getCalendarDaysResponse/event/attendeeEventExtra/{any} (minOccurs=0 maxOccurs=unbounded) provides for additional attendee extra properties.

The /getCalendarDaysResponse/event/attachment (minOccurs=0 maxOccurs=unbounded) element contains attachment metadata, name, content-type and id's, and may also contain the attachmentBody. The /getCalendarDaysResponse/event/attachment/@changeNumber (minOccurs=1maxOccurs=1) changeNumber attribute is designed to facilitate caching of the element and its descendants. This attribute is assigned to this element by the .NET My Services system. The attribute is read only to applications. Attempts to write this attribute are silently ignored.

The /getCalendarDaysResponse/event/attachment/@id (minOccurs=1maxOccurs=1) attribute is a globally unique ID assigned to this element by .NET My Services. Normally, NET My Services generates and assigns this ID during an insertRequest operation, or possibly during a replaceRequest. Application software can override this ID generation by specifying the useClientIds attribute in the request message. After an ID has been assigned, the attribute is read only and attempts to write it are silently ignored.

The /getCalendarDaysResponse/event/attachment/@creator (minOccurs=1 maxOccurs=1) attribute identifies the creator in terms of userId, appId, and platformId of the node. The /getCalendarDaysResponse/event/attachment/name (string minOccurs=1 max Occurs=1) element contains information about an individual attachment in a mail message. The /getCalendarDaysResponse/event/attachment/name/@xml:lang (minOccurs=1 maxOccurs=1) required attribute is used to specify an ISO 639 language code or an ISO 3166 country code as described in RFC 1766. The value of this attribute indicates the language type of the content within this element. The /getCalendarDaysResponse/event/attachment/name/@dir (string minOccurs=0 maxOccurs=1) optional attribute specifies the default layout direction for the localized string. Valid values are rtl (right to left) and ltr (left to right).

The /getCalendarDaysResponse/event/attachment/contentType (string minOccurs=1 maxOccurs=1) element contains the content type of the attachment. The /getCalendarDaysResponse/event/attachment/contentTransferEncoding (string minOccurs=1 maxOccurs=1) element contains the encoding of the attachment. This information is necessary for decoding the attachment. The /getCalendarDaysResponse/event/attachment/size (unsignedLong minOccurs=1maxOccurs=1) element contains the size of the attachment in bytes. The /getCalendarDaysResponse/event/attachment/attachmentBody (base64Binary minOccurs=1maxOccurs=1) element contains the contents of the attachment.

The /getCalendarDaysResponse/event/reminder (minOccurs=0 maxOccurs=1) is directed to reminders. A user may optionally define a reminder for this appointment. Reminders for recurring appointments will be sent periodically before the appointment, as per the rules defined in the reminder subschema below. A non-recurring event may define no reminders, define a reminder with <set> “true” or define a reminder with <set> “false”.

A recurring meeting may have no reminders defined, or a recurring reminder defined with all instances receiving reminders. To define no reminders by default, but to define reminders for particular meeting instances in the exception body, a reminder <set> =“false” is created, and turned on and/or modified for particular instances. To define a recurring reminder, but turn it off for particular meeting instances, a reminder <set> =“true” is created, and turned off for particular instances.

If the event's reminder subschema is non-existent, yet the exception body has a reminder blob, then the exception reminder is ignored. An alternative is to require this.

The /getCalendarDaysResponse/event/reminder/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /getCalendarDaysResponse/event/reminder/@id (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /getCalendarDaysResponse/event/reminder/@creator (minOccurs=1 maxOccurs=1) attribute identifies the creator in terms of userId, appId, and platformId of the node. The /getCalendarDaysResponse/event/reminder/set (boolean minOccurs=1 maxOccurs=1) field maintains a Boolean flag that indicates whether the reminder is active for this event. In most cases, this will be true, but in the case of a recurring appointment, this flag may default to true with specific instances not to be reminded, or default to false, with specific instances to be reminded.

The /getCalendarDaysResponse/event/reminder/to (string minOccurs=1 maxOccurs=1) stores a friendly name that this reminder is being sent to. The /getCalendarDaysResponse/event/reminder/to/@xml:lang (minOccurs=1 maxOccurs=1) required attribute is used to specify an ISO 639 language code or an ISO 3166 country code as described in RFC 1766. The value of this attribute indicates the language type of the content within this element. The /getCalendarDaysResponse/event/reminder/to/@dir (string minOccurs=0 maxOccurs=1) optional attribute specifies the default layout direction for the localized string. Valid values are rtl (right to left) and ltr (left to right).

The /getCalendarDaysResponse/event/reminder/offset (int minOccurs=1 maxOccurs=1) field specifies the offset, in minutes, of how long before the event the user should be reminded. Recommended values are set forth in the following table:

| Value | Description |
|---|---|
| 5, 10, 20, 30, 45 | 5, 10, 20, 30, 45 minutes before the event |
| 60, 120, 180, | 1, 2, 3 hours before the event |
| startTime-startDay | The day of the event (reminder sent at |
| | 12:00 am) |
| startTime-(startDay-(1440* | “x” days before the event (reminder sent |
| x)) | at 12:00 am “x” days before) |

The /getCalendarDaysResponse/event/reminder/interruptability (int minOccurs=0 maxOccurs=1) optional element defines how interruptible this event is and it is used by notification routing software to make decisions about the relay and deferral of notifications that might occur while this meeting is active. The value contained in this element is a numeric value between one and ten. Low values represent a high cost of disruption, high values represent a low cost of disruption.

The /getCalendarDaysResponse/event/reminder/lastSentTime (dateTime minOccurs=1 maxOccurs=1) field is required by the reminder engine. The /getCalendarDaysResponse/event/reminder/nextTriggerTime (dateTime minOccurs=1 maxOccurs=1) determines the next time to trigger reminder.

The /getCalendarDaysResponse/event/attendee (minOccurs=0 maxOccurs=unbounded) includes the attendeeType, which contains the information about an attendee, including the display, email, puid, and the attendee's response.

The /getCalendarDaysResponse/event/attendee/name (string minOccurs=0 maxOccurs=1) optional element specifies the name for the enclosing element. The /getCalendarDaysResponse/event/attendee/name/@xml:lang (minOccurs=1 maxOccurs=1) required attribute is used to specify an ISO 639 language code or an ISO 3166 country code as described in RFC 1766. The value of this attribute indicates the language type of the content within this element. The /getCalendarDaysResponse/event/attendee/name/@dir (string minOccurs=0 maxOccurs=1) optional attribute specifies the default layout direction for the localized string. Valid values are rtl (right to left) and ltr (left to right).

The /getCalendarDaysResponse/event/attendee/puid (string minOccurs=0 maxOccurs=1) optional element specifies the PUID for the enclosing element. The /getCalendarDaysResponse/event/attendee/email (string minOccurs=0 maxOccurs=1) optional name specifies an e-mail address for the enclosing element. The /getCalendarDaysResponse/event/attendee/inviteType (string minOccurs=1 maxOccurs=1) is used by a meeting organizer to define the kind of invitee, e.g., as required, optional, or a resource (e.g., meeting room).

The /getCalendarDaysResponse/event/attendee/responseTime (dateTime minOccurs=0 maxOccurs=1) reply time on each attendee is set to the current time (Now) when the organizer sends a meeting invitation. When the attendee responds, they update their responseTime. When the organizer receives responses, they will honor only those that have a higher responseTime than what s/he maintains in his/her own copy of the event for each attendee. While processing the response, the organizer will update their responseTime. This guarantees that the organizer honors only the most recent response from the attendee. This is stored in UTC.

The /getCalendarDaysResponse/event/attendee/counterProposeStartTime (dateTime minOccurs=0 maxOccurs=1) field contains the counter proposal start time information. If responseType=[counterPropose], then either the {startTime, endTime}, or location, or both can be present. This is the invitee's counterProposal for a new start time for the meeting. This is stored in UTC.

The /getCalendarDaysResponse/event/attendee/counterProposeEndTime (dateTime minOccurs=0 maxOccurs=1) field contains the counter proposal end time information. If responseType=[counterPropose], then either the {startTime, endTime}, or location, or both can be present. This is the invitee's counterproposal for a new end time for the meeting. This is stored in UTC.

The /getCalendarDaysResponse/event/attendee/counterProposeLocation (string minOccurs=0 maxOccurs=1) field contains the counter proposal location information. field contains the counter proposal start time information. If responseType=[counterPropose], then either the {startTime, endTime}, or location, or both can be present. This is the invitee's counterproposal for a location for the meeting.

The /getCalendarDaysResponse/event/attendee/responseBody (string minOccurs=0 maxOccurs=1) field contains an optional message for invitees to include along with the response. The /getCalendarDaysResponse/event/attendee/responseBody/@xml:lang (minOccurs=1maxOccurs=1) required attribute is used to specify an ISO 639 language code or an ISO 3166 country code as described in RFC 1766. The value of this attribute indicates the language type of the content within this element. The /getCalendarDaysResponse/event/attendee/responseBody/@dir (string minOccurs=0 maxOccurs=1) optional attribute specifies the base direction of directionally neutral text. Possible values include rtl (right to left) and ltr (left to right).

The /getCalendarDaysResponse/event/attendee/{any} (minOccurs=0 maxOccurs=unbounded) allows for extensibility.

The /getCalendarDaysResponse/event/recurrence/rule (minOccurs=1 maxOccurs=1) includes /getCalendarDaysResponse/event/recurrence/rule/creationDate (dateTime minOccurs=1maxOccurs=1), which is required to determine which timezone recurrence rule to use. The startTime of the event is not used because of the ability to create events in the past and in the future.

The /getCalendarDaysResponse/event/recurrence/rule/firstDayOfWeek (string minOccurs=1maxOccurs=1) stores what the first day of the week is for this user. Typical values are (su) Sunday or (mo) Monday. This is used for calculating the recurrence expansion, and allows recurring meetings to be expanded in the organizer's FirstDOW instead of the invitee's FirstDOW.

The /getCalendarDaysResponse/event/recurrence/rule/tzid (int minOccurs=0 maxOccurs=1) field identifies the time zone for this recurring event. All dateTime information in this event is stored in UTC (converted from the local time zone defined by the time zone sub-schema). If this field is absent, the recurring event is assumed to be recurring in UTC time. However, it is only a floating recurring event if the <floating> attribute is set:

<timeZone floating=“...”~

id
=“...”>
1..1

<standardBias>

1..1
</standardBias>

<additionalDaylightBias>

0..1
</additionalDaylightBias>

<standardDate>

0..1

<transitionRule weekdayOfMonth=“...” day=“...” dayOfMonth=“...” month=“...”

afterDay=“...”>
1..1
</transitionRule>

<transitionTime>

1..1
</transitionTime>

</standardDate>
<daylightDate>

0..1

<transitionRule weekdayOfMonth=“...” day=“...” dayOfMonth=“...” month=“...”

afterDay=“...”>
1..1
</transitionRule>

<transitionTime>

1..1
</transitionTime>

</daylightDate>

</timeZone>

The /getCalendarDaysResponse/event/recurrence/rule/isLeapYear (boolean minOccurs=0 maxOccurs=1) provides International calendar support. It is possible to derive isLeapYear from leapMonthValue, but .NET Calendar stores both separately. The /getCalendarDaysResponse/event/recurrence/rule/leapMonthvalue (int minOccurs=0 maxOccurs=1) <leapMonthValue> cannot be derived from a particular year and thus must be stored. For example, a user creates a recurrence on a Hebrew Lunar calendar. The year is a leap year and it has 13 months. In that year, the leapMonthValue is 7.

The /getCalendarDaysResponse/event/recurrence/rule/repeat (minOccurs=l maxOccurs=1) may includes the /getCalendarDaysResponse/event/recurrence/rule/repeat/daily (minOccurs=0 maxOccurs=1), field, which specifies the number of days to repeat, e.g., repeat every [. . . ] days. The /getCalendarDaysResponse/event/recurrence/rule/repeat/daily/@dayFrequency (int minOccurs=1maxOccurs=1) specifies the periodicity of days over which repetition occurs, for example, repeat every 3 days.

The /getCalendarDaysResponse/event/recurrence/rule/repeat/weekly (minOccurs=0 maxOccurs=1) field, if present, is directed to repeating weekly, e.g., repeat every [. . . ] week(s) on {su, mo, tu, we, th, fr, sa}. The presence of a weekday attribute means to repeat on this particular day. Any combination of the seven days is valid.

The /getCalendarDaysResponse/event/recurrence/rule/repeat/weekly/@weekFrequency (int minOccurs=0 maxOccurs=1) repeatWeekly recurrence occurs every period of weeks. If the attribute is not present, it defaults to 1 (every week).

The /getCalendarDaysResponse/event/recurrence/rule/repeat/monthlyByDay (minOccurs=0 maxOccurs=1) specifies to repeat on the [First, Second, Third, Fourth, Last] {Su, mo, tu, we, th, fr, sa} of every [. . . ] month(s). Any combination of the {weekday} attributes are valid, including user-defined combinations for weekdays and weekend days.

The /getCalendarDaysResponse/event/recurrence/rule/repeat/monthlyByDay/@monthFrequency (int minOccurs=0 maxOccurs=1) specifies the month periodicity to recur on. If this attribute is not present, it defaults to 1 (every month).

The /getCalendarDaysResponse/event/recurrence/rule/repeat/monthlyByDay/@weekdayOfMonth (string minOccurs=1maxOccurs=1) specifies which week in a month [first, second, third, fourth, last].

The /getCalendarDaysResponse/event/recurrence/rule/repeat/monthly (minOccurs=0 maxOccurs=1) repeats the occurrence every month on a particular day. The very first occurrence is created from the parent event's startTime and endTime, but the recurrence occurs as follows: Repeat every month on [day] of [month]. Repeat every [monthFrequency] month(s) on [day] of [month]. Typically, the first occurrence is also an instance of the recurrence, but this need not be the case.

The /getCalendarDaysResponse/event/recurrence/rule/repeat/monthly/@monthFrequency (int minOccurs=0 maxOccurs=1) optional attribute indicates the month periodicity. By default, it is 1, periodic every month. The start of the periodicity is determined from event startTime. The /getCalendarDaysResponse/event/recurrence/rule/repeat/monthly/@day (int minOccurs=1 maxOccurs=1) specifies the day of the month to recur on. Value is between one and 31.

A forceExact rule handles invalid day-month combinations. The proper recurrence pattern for repeating on the last day of the month is to use repeatMonthlyByDay. “Repeat on the [last] [day, weekday, weekend day] of . . . ”. By default, an invalid day-month combination will cause .NET Calendar to search backwards to find a valid day-month combination. If /getCalendarDaysResponse/event/recurrence/rule/repeat/monthly/@forceExact (boolean minOccurs=0 maxOccurs=1) is true, an invalid starting [month ,day] combination such as [6, 31] is ignored and will not be included as an instance of the recurrence. With forceExact, day=31 will only pick up months that have 31 days, day=30 will pick up all months except February, day-29 will pick up all months except February, except on leap years. February 29 is included on leap years.

The /getCalendarDaysResponse/event/recurrence/rule/repeat/yearlyByDay (minOccurs=0 maxOccurs=1) specifies how to repeat on the [First, Second, Third, Fourth, Last] {su, mo, tu, we, th, fr, sa} of [Jan, Feb, Mar, Apr, May, Jun, Jul, Aug, Sep, Oct, Nov, Dec] every [yearFrequency] years.

Any combination of the {weekday} attributes are valid, including user-defined combinations denoting weekdays and weekend days. This element's attributes contain whether a given day is or is not considered by the user as part of the work week. If this element has no attributes, it is assumed that the user has a Monday to Friday work week.

The /getCalendarDaysResponse/event/recurrence/rule/repeat/yearlyByDay/@yearFrequency (int minOccurs=0 maxOccurs=1) optional attribute indicates the year periodicity. By default, it is 1 (repeat every year).

The (string minOccurs=1 maxOccurs=1) Specifies which week in a month [first, second, third, fourth, last] to repeat.

The /getCalendarDaysResponse/event/recurrence/rule/repeat/yearlyByDay/@month (int minOccurs=1 maxOccurs=1) contains a value between one and thirteen (some calendars have thirteen months).

The /getCalendarDaysResponse/event/recurrence/rule/repeat/yearly (minOccurs=0 maxOccurs=1) specifies to repeat every year on a particular date. The very first occurrence is created from the parent event's startTime and endTime, but the recurrence occurs as follows: Repeat yearly on [day] of [month]. Repeat every [yearFrequency] years on [day] of [month]. Typically, the first occurrence is also an instance of the recurrence, but this need not be the case.

The /getCalendarDaysResponse/event/recurrence/rule/repeat/yearly/@yearFrequency (int minOccurs=0 maxOccurs=1) optional attribute indicates the year periodicity. By default, it is 1 (repeat every year). The /getCalendarDaysResponse/event/recurrence/rule/repeat/yearly/@month (int minOccurs=1 maxOccurs=1) specifies the month to recur on.

The /getCalendarDaysResponse/event/recurrence/rule/repeat/yearly/@day (int minOccurs=1maxOccurs=1) specifies the day of the month to recur on. The value is between 1-31, and forceExact, applies for invalid day-month combinations. Thus, by default, an invalid day-month-year combination will cause .NET Calendar to search backwards to find a valid day for a particular month, year. If /getCalendarDaysResponse/event/recurrence/rule/repeat/yearly/@forceExact (boolean minOccurs=0 maxOccurs=1) is true, an invalid starting [month ,day] combination such as [6, 31] is ignored and will not be included as an instance of the recurrence. With forceExact, .NET Calendar, day=31 will only pick up months that have 31 days, day=30 will pick up all months except February, day=29 will pick up all months except February, except on leap years. February 29 is included on leap years.

The /getCalendarDaysResponse/event/recurrence/rule/repeat/{any} (minOccurs=0 maxOccurs=unbounded) allows for any additional repeat rules.

The /getCalendarDaysResponse/event/recurrence/rule/windowEnd (dateTime minOccurs=0 maxOccurs=1) field indicates the end of the window over which the recurrence occurs. This is stored in UTC. The Maximum range is Jan. 1, 1753 to December 31, 9999 to an accuracy of 3.33 milliseconds. Note that windowEnd, repeatForever, repeatInstances may be selectable.

The /getCalendarDaysResponse/event/recurrence/rule/repeatForever (boolean minOccurs=0 maxOccurs=1) overrides the windowEnd date and specifies that this recurrence repeats forever. Client implementations cannot depend on date values repeating forever, like 23:59:59 pm Dec 31, 9999 or 23:59 Aug 31, 4500.

The /getCalendarDaysResponse/event/recurrence/rule/repeatInstances (int minOccurs=0 maxOccurs=1) overrides the windowEnd date and specifies that this recurrence repeats for the specified number of instances. As is apparent, repeatInstances and repeatForever are mutually exclusive, but repeatInstances will override repeatForever for errant schemas.

Note that if the method causes a failure response to be generated, the failure is noted by generation of a SOAP Fault message. Failures can include a failure to understand a header marked as “s:mustUnderstand”, a .NET My Services standard error, security violation, load-balance redirect, or any service-specific severe error condition.

The myCalendar/getFreeBusyDays Method is accessed using a request message, and in response may generate a response message or a SOAP Fault message. The following sample document outlines and descriptions below illustrate the structure and meaning of the elements and attributes in the request and response messages:

<m:getFreeBusyDaysRequest

xmlns:m=“http://schemas.microsoft.com/hs/2001/10/myCalendar”
xmlns:hs=“http://schemas.microsoft.com/hs/2001/10/core”>_{1..1}
<m:calendarType>_{0..1}</m:calendarType>
<m:startTime>_{1..1}</m:startTime>
<m:endTime>_{1..1}</m:endTime>
<m:getFreeBlocks>_{0..1}</m:getFreeBlocks>
<m:returnIndividualBlocks>_{0..1}</m:returnIndividualBlocks>

</m:getFreeBusyDaysRequest>

The /getFreeBusyDaysRequest (minOccurs=1maxOccurs=1) function returns a stream of xml fragments defining the user's freeBusy information between two dates. Single events and recurring events within the time window are translated into blocks of free/busy time. The getFreeBusyDays only returns the blocks and their associated type. There is no explicit method to return unmerged freeBusy info, as that kind of behavior is fully contained within getCalendarDays.

This method follows the precedence order: Away(OOF), Busy, Tentative, Free. Overlapping blocks of the same freeOrBusyStatus kind are coalesced to form larger blocks. Overlapping blocks of different freeOrBusyStatus are overlaid. The events with higher precedence overlay on top (not by starting time). For example, Busy from 8 to 9, Tentative from 8:30 to 10, OOF from 9:30 to 11, Free from 10:30 to 12, is merged as Busy from 8 to 9, Tentative from 9 to 9:30, OOF from 9:30 to 11, Free from 11 to 12. The freeBusy information of multiple users is retrieved by specifying a puid for each user in question. The caller of this function needs to specify their own puid, no implicit assumptions are made.

The calling method takes a startDate and an endDate to define the duration over which freeBusy information is returned. A third parameter determines if free blocks are explicitly returned. Free blocks are intervals where no calendar object exists. The getFreeBusyDays method may be used to retrieve multiple calendar data from other users using <h:key instance=“0” cluster=“0” puid=“xyz”> in the SOAP headers provided that puid “xyz” is provisioned on the .NET Calendar server, and provided that the user has been granted access in puid “xyz”'s roleList.

The /getFreeBusyDaysRequest/calendarType (string minOccurs=0 maxOccurs=1) contains the optional calendar type to return, with the default being Gregorian. The /getFreeBusyDaysRequest/startTime (dateTime minOccurs=1maxOccurs=1) field contains the starting time window of calendar objects to retrieve. This dateTime also contains the timeZone to retrieve the calendar information in.

The /getFreeBusyDaysRequest/endTime (dateTime minOccurs=1maxOccurs=1) field contains the ending time window to retrieve calendar objects. This dateTime also contains the timeZone to retrieve the calendar information in, and needs to be the same timeZone as startTime.

The /getFreeBusyDaysRequest/getFreeBlocks (boolean minOccurs=0 maxOccurs=1) boolean causes .NET Calendar to explicitly return free time as freeBusy blocks. By default, free blocks are not returned. The /getFreeBusyDaysRequest/returnIndividualBlocks (boolean minOccurs=0 maxOccurs=1) boolean causes .NET Calendar not to coalesce/merge freeBusy information. By default, freeBusy information is merged.

Upon successful completion of the getFreeBusyDays method, a myCalendar/getFreeBusyDaysResponse response message is generated. The format of the response message is described below:

<m:getFreeBusyDaysResponse selectedNodeCount=“...” status“...”

xmlns:m=“http://schemas.microsoft.com/hs/2001/10/myCalendar”
xmlns:hs=“http://schemas.microsoft.com/hs/2001/10/core”>_{1..1}
<m:freeOrBusyEvent>_{0..unbounded}

<m:startTime>_{1..1}</m:startTime>
<m:endTime>_{1..1}</m:endTime>
<m:type>_{1..1}</m:type>

</m:freeOrBusyEvent>

</m:getFreeBusyDaysResponse>

The /getFreeBusyDaysResponse (minOccurs=1 maxOccurs=1) response XML blob format, comprises freeBusy xml fragments. The /getFreeBusyDaysResponse/@selectedNodeCount (int minOccurs=0 maxOccurs=1) attribute is used to return the number of selected nodes, selected by the corresponding data language operation.

The /getFreeBusyDaysResponse/@status (string minOccurs=1 maxOccurs=1) attribute indicates the status of the method, e.g., success when the corresponding method was completed successfully, failure when the corresponding method was not completed successfully, rollback when the method failed, but was rolled back to its pre-updateBlock status, or notAttempted when the corresponding method was not attempted. This occurs when a previous operation failed.

The /getFreeBusyDaysResponse/freeOrBusyEvent (minOccurs=0 maxOccurs=unbounded) includes /getFreeBusyDaysResponse/freeOrBusyEvent/startTime (dateTime minOccurs=1 maxOccurs=1) which specifies the start time, /getFreeBusyDaysResponse/freeOrBusyEvent/endTime (dateTime minOccurs=l maxOccurs=1) which specifies the end time, and /getFreeBusyDaysResponse/freeOrBusyEvent/type (string minOccurs=1maxOccurs=1) which specifies the type, including free, tentative, busy or away.

The myCalendar/getQuickView Method provides a QuickView/DatePicker service function. The following table and description below describes the request message for this method:

<m:getQuickViewRequest

xmlns:m=“http://schemas.microsoft.com/hs/2001/10/myCalendar”
xmlns:hs=“http://schemas.microsoft.com/hs/2001/10/core”>_{1..1}
<m:calendarType>_{0..1}</m:calendarType>
<m:startTime>_{1..1}</m:startTime>
<m:endTime>_{1..1}</m:endTime>
<m:tzid>_{0..1}</m:tzid>
<m:biasOffset>_{0..1}</m:biasOffset>

</m:getQuickViewRequest>

The /getQuickViewRequest (minOccurs=1maxOccurs=1) function provides an efficient, lightweight means to query a date range to indicate days that have 1 or more appointments (1) and days without appointments (0). Outlook® and OWA® (Outlooks Web Access) use this for their datePicker functionality. The date range takes timeZone-specific start and end times, using just the year, month, and day. The time zone can be a simple bias, since this is merely a request for data. startTime and endTime are required to have the same time-zone bias. In effect, the method “overlays” the incoming time zone onto the user's calendar to define the dayblocks for which the QuickView returns data.

The /getQuickViewRequest/calendarType (string minOccurs=0 maxOccurs=1) provides a field for the Optional calendar type to return, with the default being Gregorian. The /getQuickViewRequest/startTime (dateTime minOccurs=1maxOccurs=1) field contains the starting time window of calendar objects to retrieve. This dateTime also contains the timeZone to retrieve the calendar information in.

The /getQuickViewRequest/endTime (dateTime minOccurs=1maxOccurs=1) specifies the ending time window to retrieve calendar objects. This dateTime also contains the timeZone to retrieve the calendar information in. It must be the same timeZone as startTime.

The /getQuickViewRequest/tzid (int minOccurs=0 maxOccurs=1) field optionally specifies a timezone to retrieve the quickview in. If this or biasOffset are both missing, TZ_UTC is assumed. The /getQuickViewRequest/biasOffset (int minOccurs=0 maxOccurs=1) field optionally specifies a numeric integer offset timezone bias to retrieve the quickview in. tzid takes precedence over biasOffset (pending xsd:choice).

Upon successful completion of the myCalendar/getQuickViewmethod, a myCalendar/getQuickViewResponse response message is generated. The format of the response message is described in the table and description below:

<m:getQuickViewResponse selectedNodeCount=“...” status=“...”

xmlns:m=“http://schemas.microsoft.com/hs/2001/10/myCalendar”
xmlns:hs=“http://schemas.microsoft.com/hs/2001/10/core”>_{1..1}
<m:month m=“...” year=“...”>_{1..unbounded}

<m:day d=“...”>_{1..31}</m:day>

</m:month>

</m:getQuickViewResponse>

The /getQuickViewResponse (minOccurs=1maxOccurs=1) return value of getQuickView is a list of calendar days grouped into months. The /getQuickViewResponse/@selectedNodeCount (int minOccurs=0 maxOccurs=1) attribute is used to return the number of selected nodes, selected by the corresponding data language operation. The /getQuickViewResponse/@status (string minOccurs=1maxOccurs=1) attribute indicates the status of the method, e.g., success when the corresponding method was completed successfully, failure when the corresponding method was not completed successfully, rollback when the method failed, but was rolled back to its pre-updateBlock status, or notAttempted when the corresponding method was not attempted. This occurs when a previous operation failed.

The /getQuickViewResponse/month (minOccurs=1maxOccurs=unbounded) field specifies the month block for the grouping of calendar days. The /getQuickViewResponse/month/@m (int minOccurs=0 maxOccurs=1) provide a month number, restrict to between one and thirteen, (as some calendars have thirteen months).

The /getQuickViewResponse/month/@year (int minOccurs=0 maxOccurs=1), provides the year, while the /getQuickViewResponse/month/day (boolean minOccurs=1maxOccurs=31) field specifies whether this day is free (0) or has at least one event on it or overlapping (1). The /getQuickViewResponse/month/day/@d (int minOccurs=0 maxOccurs=1) field specifies a day in this month.

The myCalendar/sendMeeting method is directed to the organizer meeting request, is accessed using a request message, and in response may generate a response message or a SOAP Fault message. The following sample document fragments illustrate the structure and meaning of the elements and attributes in the request and response messages. The following table and description below describes the request message for this method:

<m:sendMeetingRequest eventId=“...” criticalChange=“...”
recurrenceId=“...” continueOnFailure=“...” deleteOnCompletion=“...”

xmlns:m=“http://schemas.microsoft.com/hs/2001/10/myCalendar”
xmlns:hs=“http://schemas.microsoft.com/hs/2001/10/core”>_{1..1}
<m:uninvite behavior=“...”>_{1..1}

<m:attendee deleteAttendee=“...”>_{0..unbounded}

<hs:name xml:lang=“...” dir=“...”>_{0..1}</hs:name>
<hs:puid>_{0..1}</hs:puid>
<hs:email>_{0..1}</hs:email>

</m:attendee>

</m:uninvite>
<m:replaceRequest select=“...” useClientIds=“...” minOccurs=“...”
maxOccurs=“...”>_{0..1}

<hs:options>_{0..1} {any}</hs:options>
<hs:attributes {any}=“...”>_{0..unbounded}</hs:attributes>
{any}

</m:replaceRequest>
<m:invite behavior=“...”>_{1..1}

<m:attendee>_{0..unbounded}

<hs:name xml:lang=“...” dir=“...”>_{0..1}<hs:name>
<hs:puid>_{0..1}</hs:puid>
<hs:email>_{0..1}</hs:email>

</m:attendee>

</m:invite>

</m:sendMeetingRequest>

The purpose of this method is for a meeting organizer to invite and uninvite (cancel) attendees to this event. The /sendMeetingRequest (minOccurs=1 maxOccurs=1) sendMeeting also sends updated invitations to existing invitees. Inviting a user to a single instance of a recurring event will cause only that instance to be sent. However, future updates to that event will overwrite the existing instance, including the case where an update is the full recurring event. Meeting requests will be sent out as attachments from an SMTP server. When inviting or uninviting, .NET Calendar searches for these existing attendees by puid first, and then by email address such that the puid receives precedence in the search predication. NET Calendar will not allow multiple meeting requests/cancellations to the same puid or email address within the scope of the same invite or uninvite block. However, an organizer may uninvite an attendee and then reinvite again (non-standard behavior).

The /sendMeetingRequest/@eventId (string minOccurs=1maxOccurs=1) field contains the puid of the event which to send meeting invitations or cancellations to. This event must already exist within the .NET Calendar service. Additional server constraints are implemented which verify that potential updates to the attendee tables occur for this event only. This is a required field.

The /sendMeetingRequest/@criticalChange (boolean minOccurs=0 maxOccurs=1) attribute, when set to “true”, causes <lastUpdateTime> to be updated when invitations are sent to the attendees. If “false”, <lastUpdateTime> remains untouched.

The /sendMeetingRequest/@recurrenceId (dateTime minOccurs=0 maxOccurs=1) optional recurrenceId allows the meeting organizer to send invitations for only a particular instance of a recurring event. If the event is not a recurring event, or if recurrenceId does not correspond to a valid instance/exception, sendMeetingRequest will fail with an error.

The /sendMeetingRequest/@continueOnFailure (boolean minOccurs=1maxOccurs=1) field specifies to .NET Calendar to continue performing the sendMeetingRequest even on a failure. Points of failure: <uninvite> may delete attendees, and the data language delete may encounter errors <updateRequest> may encounter data language errors. The optional final delete of the event may encounter errors.

The /sendMeetingRequest/@deleteOnCompletion (boolean minOccurs=0 maxOccurs=1) event will be deleted upon completion of this sendMeetingRequest. This behavior is intended for deleting a meeting and sending cancellations. If recurrenceId is present (and valid), only this particular recurring instance or exception is deleted, in which case a new <deletedExceptionDate> is added to the recurrence rule.

The /sendMeetingRequest/uninvite (minOccurs=1 maxOccurs=1) includes The /sendMeetingRequest/uninvite/@behavior (string minOccurs=0 maxOccurs=1), an attribute that gives the option to either choose to send cancellations to “all” attendees in the event's attendee table, or send to “none” of them. A third value of “default” would give the default behavior of sending cancellations to all attendees who are replaced in the <replaceRequest>block. When this attribute is set, .NET Calendar will ignore anything within the <uninvite>node.

The /sendMeetingRequest/uninvite/attendee (minOccurs=0 maxOccurs=unbounded) field contains a list of people to uninvite. Uninvited attendees must already exist in the organizer's attendee table, or else these users are ignored.

The /sendMeetingRequest/uninvite/attendee/@deleteAttendee (boolean minOccurs=0 maxOccurs=1) field optionally specifies whether or not to delete this attendee from the organizer's attendee table. If the attendee is not deleted, .NET Calendar will not know the status of this attendee because the status {not-sent, sent, cancelled} is not stored per-attendee.

The /sendMeetingRequest/uninvite/attendee/name (string minOccurs=0 maxOccurs=1) optional element specifies the name for the enclosing element. The /sendMeetingRequest/uninvite/attendee/name/@xml:lang (minOccurs=1 maxOccurs=1) required attribute is used to specify an ISO 639 language code or an ISO 3166 country code as described in RFC 1766. The value of this attribute indicates the language type of the content within this element. The /sendMeetingRequest/uninvite/attendee/name/@dir (string minOccurs=0 maxOccurs=1) optional attribute specifies the default layout direction for the localized string. Valid values are rtl (right to left) and ltr (left to right).

The /sendMeetingRequest/uninvite/attendee/puid (string minOccurs=0 maxOccurs=1) optional element specifies the PUID for the enclosing element. The /sendMeetingRequest/uninvite/attendee/email (string minOccurs=0 maxOccurs=1) optional name specifies an e-mail address for the enclosing element.

The /sendMeetingRequest/replaceRequest (minOccurs=0 maxOccurs=1) replace request can only affect the meeting invitation in question, and is thus constrained to be only @select=“/m:myCalendar/m:event[@id=@eventId]/ . . . ”. It will not be allowed to replace-on-null so that event creation cannot be a side-effect. The /sendMeetingRequest/replaceRequest/@select (string minOccurs=1maxOccurs=1) attribute selects an xdb:blue or an xdb:red.

The /sendMeetingRequest/replaceRequest/@useClientIds (string minOccurs=0 maxOccurs=1) attribute specifies that, if an xdb:blue item is created during an insert or replace operation, and an ID would normally be generated, the ID specified in the request content should be used instead of having .NET My Services generate an ID. Applications using this option must ensure that they are properly generating unique IDs in the form of UIDs. They must also ensure that they do not assign the same ID to multiple xdb:blue items; this can happen if the insert select attribute selects multiple nodes.

The /sendMeetingRequest/replaceRequest/@minOccurs (int minOccurs=0 maxOccurs=1) optional attribute specifies the minimum number of nodes that must be selected by the select operation in order for this operation to be successfully attempted. The default value is zero, meaning that if no nodes are selected, the operation silently succeeds as a non operation (“NOP”). A value of one means that a minimum of one node must be selected. In that case, if no nodes are selected, the operation fails with an error.

The /sendMeetingRequest/replaceRequest/@maxOccurs (int minOccurs=0 maxOccurs=1) optional attribute specifies the maximum number of nodes that may be selected by the select operation in order for this operation to be successfully attempted. The default value is unbounded. If the number of nodes selected by the select attribute is greater than this value, an error condition occurs. The /sendMeetingRequest/replaceRequest/options (minOccurs=0 maxOccurs=1) provide for options.

The /sendMeetingRequest/replaceRequest/options/{any} (minOccurs=0 maxOccurs=unbounded) includes /sendMeetingRequest/replaceRequest/attributes (minOccurs=0 maxOccurs=unbounded). This element is used to specify a single attribute to be manipulated by the .NET My Services data-manipulation primitives. For example, when used in an insertRequest, this element specifies an attribute to be inserted at the specified node.

The /sendMeetingRequest/replaceRequest/attributes/@{any} (minOccurs=0 maxOccurs=1) and /sendMeetingRequest/replaceRequest/{any} (minOccurs=0 maxOccurs=unbounded) fields provide for extensibility. This element is a placeholder that indicates where the content of the item being replaced is to be specified.

The /sendMeetingRequest/invite (minOccurs=1 maxOccurs=1) includes the /sendMeetingRequest/invite/@behavior (string minOccurs=0 maxOccurs=1) attribute. This attribute will give the option to either choose to send invitations to “all” attendees in the event's attendee table, or send to “none” of them. A third value of “default” would give the default behavior of sending invitations to only the new attendees in the <replaceRequest> block. When this attribute is set, .NET Calendar will ignore anything within the <invite>node.

The /sendMeetingRequest/invite/attendee (minOccurs=0 maxOccurs=unbounded) field contains information about this attendee to be invited. An invited attendee must already exist in the organizer's attendee table. This attendee may originally be there prior to the sendMeetingRequest method, or be the result of the update operation to this meeting. To change the attendee's inviteType, the update operation should be used.

When invitations are sent, the attendee's <responseTime> is set to the current time (now) as a side-effect. The /sendMeetingRequest/invite/attendee/name (string minOccurs=0 maxOccurs=1) optional element specifies the name for the enclosing element. The /sendMeetingRequest/invite/attendee/name/@xml: lang (minOccurs=1 maxOccurs=1) required attribute is used to specify an ISO 639 language code or an ISO 3166 country code as described in RFC 1766. The value of this attribute indicates the language type of the content within this element. The /sendMeetingRequest/invite/attendee/name/@dir (string minOccurs=0 maxOccurs=1) optional attribute specifies the default layout direction for the localized string. Valid values are rtl (right to left) and ltr (left to right).

The /sendMeetingRequest/invite/attendee/puid (string minOccurs=0 maxOccurs=1) optional element specifies the PUID for the enclosing element. The /sendMeetingRequest/invite/attendee/email (string minOccurs=0 maxOccurs=1) optional name specifies an e-mail address for the enclosing element.

The myCalendar/respond method provides a method for invitees to respond to an invite. The following table and accompanying description below illustrate the structure and meaning of the elements and attributes in the request and response messages:

xmlns:m=“http://schemas.microsoft.com/hs/2001/10/myCalendar”

xmlns:hs=“http://schemas.microsoft.com/hs/2001/10/core”>_{1..1}
<m:responseTime>_{0..1}</m:responseTime>
<m:responseType>_{0..1}</m:responseType>
<m:counterProposeStartTime>_{0..1}</m:counterProposeStartTime>
<m:counterProposeEndTime>_{0..1}</m:counterProposeEndTime>
<m:counterProposeLocation>_{0..1}</m:counterProposeLocation>
<m:responseBody xml:lang=“...” dir=“...”>_{0..1}</m:responseBody>
<m:eventId>_{1..1}</m:eventId>
<m:puid>_{1..1}</m:puid>

</m:respondRequest>

The purpose of this method is for a meeting invitee to respond to an invitation. Invitees may accept, decline, accept tentatively, or counterpropose in some means. Currently, allow the counterproposing of time and location, but we may consider future additions.

The /respondRequest (minOccurs=1maxOccurs=1) includes /respondRequest/responseTime (dateTime minOccurs=0 maxOccurs=1), field is the reply time on each attendee, set to the current time (Now) when the organizer sends a meeting invitation. When the attendee responds, they update their responseTime. When the organizer receives responses, they will honor only those that have a higher responseTime than what he or she maintains in his or her own copy of the event for each attendee. While processing the response, the organizer will update their responseTime. This guarantees that the organizer honors only the most recent response from the attendee. This is stored in UTC.

The /respondRequest/responseType (string minOccurs=0 maxOccurs=1) accept status indicates the valid types of responses that an attendee can reply with {accept, decline, tentative, counterpropose}. The absence of this field indicates that no response has been recorded (either the invitation has not been sent, or that a reply has not been received).

The /respondRequest/counterProposeStartTime (dateTime minOccurs=0 maxOccurs=1) field contains the counter proposal start time information. If responseType=[counterPropose], then either the startTime, endTime, or location, or all three can be present. This is the invitee's counterProposal for a new start time for the meeting. This is stored in UTC.

The /respondRequest/counterProposeEndTime (dateTime minOccurs=0 maxOccurs=1) field contains the counter proposal end time information. If responseType=[counterPropose], then either the {startTime, endTime}, or location, or both can be present. This is the invitee's counterProposal for a new end time for the meeting. This is stored in UTC.

The /respondRequest/counterProposeLocation (string minOccurs=0 maxOccurs=1) field contains the counter proposal location information. field contains the counter proposal start time information. If responseType=[counterPropose], then either the {startTime, endTime}, or location, or both can be present. This is the invitee's counterproposal for a location for the meeting.

The /respondRequest/responseBody (string minOccurs=0 maxOccurs=1) field contains an optional message for invitees to include along with the response. The /respondRequest/responseBody/@xml:lang (minOccurs=1maxOccurs=1) required attribute is used to specify an ISO 639 language code or an ISO 3166 country code as described in RFC 1766. The value of this attribute indicates the language type of the content within this element. The /respondRequest/responseBody/@dir (string minOccurs=0 maxOccurs=1) optional attribute specifies the base direction of directionally neutral text. Possible values include rtl (right to left) and ltr (left to right).

The /respondRequest/eventId (string minOccurs=1 maxOccurs=1) field contains the eventId for the meeting, and the /respondRequest/puid (string minOccurs=1maxOccurs=1) field identifies the invitee.

The myCalendar/updateReminder Method provides a Delegate function to the .NET Alerts service for creating or modifying calendar meeting reminders. The following sample document in the table and accompanying description below illustrate the structure and meaning of the elements and attributes in the request and response messages:

<m:updateReminderRequest

xmlns:m=“http://schemas.microsoft.com/hs/2001/10/myCalendar”
xmlns:hs=“http://schemas.microsoft.com/hs/2001/10/core”>_{1..1}
<m:reminder>_{1..1}

<m:set>_{1..1}</m:set>
<m:to xml:lang=“...” dir=“...”>_{1..1}</m:to>
<m:offset>_{1..1}</m:offset>
<m:interruptability>_{0..1}</m:interruptability>
<m:lastSentTime>_{1..1}</m:lastSentTime>
<m:nextTriggerTime>_{1..1}</m:nextTriggerTime>

</m:reminder>
<m:id>_{1..1}</m:id>

</m:updateReminderRequest>

The /updateReminderRequest (minOccurs=1maxOccurs=1) function is used to update the status of a reminder once the user has received the notification. It also may be exposed as an HTTP API so that non-.NET My Services clients have a means to dismiss, snooze, or be reminded again at a different time. The /updateReminderRequest/reminder (minOccurs=1 maxOccurs=1) includes the /updateReminderRequest/reminder/set (boolean minOccurs=1 maxOccurs=1) Boolean flag that indicates whether the reminder is active for this event. In most cases, this will be true, but in the case of a recurring appointment, this flag may default to true with specific instances not to be reminded, or default to false, with specific instances to be reminded.

The /updateReminderRequest/reminder/to (string minOccurs=1maxOccurs=1) field contains the friendly name that this reminder is being sent to. The /updateReminderRequest/reminder/to/@xml:lang (minOccurs=1maxOccurs=1) required attribute is used to specify an ISO 639 language code or an ISO 3166 country code as described in RFC 1766. The value of this attribute indicates the language type of the content within this element. The /updateReminderRequest/reminder/to/@dir (string minOccurs=0 maxOccurs=1) optional attribute specifies the default layout direction for the localized string. Valid values are rtl (right to left) and ltr (left to right).

The /updateReminderRequest/reminder/offset (int minOccurs=1maxOccurs=1) field specifies the offset, in minutes, of how long before the event the user should be reminded. Recommended values are the following:

| Value | Description |
|---|---|
| 5, 10, 20, 30, 45 | 5, 10, 20, 30, 45 minutes before the event |
| 60, 120, 180, | 1, 2, 3 hours before the event |
| startTime-startDay | The day of the event (reminder sent at |
| | 12:00 am) |
| startTime-(startDay-1440* | “x” days before the event (reminder sent |
| x)) | at 12:00 am “x” days before) |

The /updateReminderRequest/reminder/interruptability (int minOccurs=0 maxOccurs=1) optional element defines how interruptible this event is and it is used by notification routing software to make decisions about the relay and deferral of notifications that might occur while this meeting is active. The value contained in this element is a numeric value between one and ten. Low values represent a high cost of disruption, high values represent a low cost of disruption.

The /updateReminderRequest/reminder/lastSentTime (dateTime minOccurs=1 maxOccurs=1) is used by the reminder engine. The /updateReminderRequest/reminder/nextTriggerTime (dateTime minOccurs=1maxOccurs=1) field determines the next time to trigger reminder. The /updateReminderRequest/id (string minOccurs=1maxOccurs=1) attribute contains a reference to another .NET My Services item by its item ID. The uuidType is used to specify a universally unique identifier (UUID).

Upon successful completion of this method, a Standard .NET My Services response message is generated as the myCalendar/updateReminderResponse.

myCalendar/Examples

By way of example, consider this stripped-down view of a sample user's calendar:

<myCalendar>

<event>

<body>

<cat ref=“hs:public”/>
<title xml:lang=“en” dir=“ltr”>Meet with attorneys</title>
<startTime> 2001-09-14T19:00:00Z </startTime>
<endTime> 2001-09-14T20:00:00Z </endTime>
<organizer>

<name>John Doe</name>
<email>johndoe@microsoft.com</email>

</organizer>

</body>

</event>

</myCalendar>

As can be seen from the various descriptions above, when interpreted by a calendar application, this would result in a single meeting on the calendar that takes place at noon Pacific Standard Time and lasts one hour.

As a more complex example, consider the following table:

<m:myCalendar
xmlns:m=“http://schemas.microsoft.com/hs/2001/10/myCalendar”

xmlns:hs=“http://schemas.microsoft.com/hs/2001/10/core”>
<m:event

calendarType=“2”>
<m:body>

<m:title xml:lang=“en” dir=“ltr”>Meet for coffee</m:title>
<m:fullDescription xml:lang=“en” dir=“ltr”>

Meet at the local coffee place to discuss
our meeting this Monday.
It takes about 30 minutes to get there.

<m:fullDescription>
<m:location>Joe's coffee shop</m:location>
<startTime>2001-09-14T13:20:00-8:00</startTime>
<endTime>2001-09-14T14:20:00-8:00</endTime>
<allDay>False</allDay>
<travelTimeTo>30</travelTimeTo>
<travelTimeFrom>30</travelTimeFrom>
<freeBusyStatus>away</freeBusyStatus>
<m:organizer>

<hs:name xml:lang=“en”
dir=“rtl”>Bob Smith</hs:name>
<hs:email>bobsmith@company.com</hs:email>

</m:organizer>

</m:body>
<m:attachment>

<m:name xml:lang=“en” dir=“rtl”>

Meeting Agenda.doc

</m:name>
<m:contentType>application/msword</m:contentType>
<m:contentTransferEncoding>

base64

</m:contentTransferEncoding>
<m:size>14324</m:size>
<m:content>4234234##32423423423423</m:content>

</m:attachment>
<m:reminder>

<m:set>true</m:set>
<m:to xml:lang=“en” dir=“rtl”></m:to>
<m:offset>30</m:offset>
<m:lastSentTime>0000-00-00T00:00:00</m:lastSentTime>
<m:nextTriggerTime>

2001-09-14T12:50:00-8:00

</m:nextTriggerTime>

</m:reminder>

</m:event>
<m:event>

<m:body>

<m:cat ref=“hs:public”/>
<m:title xml:lang=“en” dir=“...”>Monday morning meeting</m:title>
<m:fullDescription xml:lang=“en” dir=“rtl”>

Meet to talk about tasks for the upcoming week.

</m:fullDescription>
<m:location xml:lang=“en” dir=“rtl”>Joe's coffee shop</m:location>
<m:recurrenceId>2001-09-01T08:00-8:00</m:recurrenceId>
<m:startTime>2001-09-01T08:00-8:00</m:startTime>
<m:endTime>2001-09-01T09:00-8:00</m:endTime>
<m:allDay>false</m:allDay>
<m:floating>false</m:floating>
<m:travelTimeTo>30</m:travelTimeTo>
<m:travelTimeFrom>30</m:travelTimeFrom>
<m:freeBusyStatus>busy</m:freeBusyStatus>

```
  </m:body>
  <m:recurrence>
```

<m:rule>

<m:creationDate>2001-09-01T08:00-8:00</m:creationDate>
<m:firstDayOfWeek>su</m:firstDayOfWeek>
<m:isLeapYear>false</m:isLeapYear>
<m:repeat>

<m:weekly su=“...” mo=“true” tu“...” we=“...”

th=“...” fr=“...” sa=“...” weekFrequency=“...”/>

<m:monthlyByDay su=“...” mo=“...” tu=“...” we=“...”

th=“...” fr=“...” sa=“...”
monthFrequency=“...” weekdayOfMonth=“...”/>

<m:monthly monthFrequency=“...” day=“...”

forceExact=“...” />

<m:yearlyByDay su=“...” mo=“...” tu=“...” we=“...”

th=“...” fr=“...” sa=“...” yearFrequency=“...”

weekdayOfMonth=“...” month=“...”/>

<m:yearly yearFrequency=“...” month=“...” day“...”

forceExact=“...”/>

</m:repeat>
<m:windowEnd>2002-01-01T12:00</m:windowEnd>
<m:repeatForever>false</m:repeatForever>
<m:repeatInstances/>

</m:rule>

</m:recurrence>
</m:event>
</m:myCalendar>

As can be seen from the descriptions above, this user has two events in a calendar. One event is recurring every Monday at 8:00 am, and the other is an upcoming event at 1:20 pm.

As can be seen from the foregoing detailed description, there is provided a schema-based calendar service that allows users to access their data based on their identities and corresponding roles with respect to the data. The schema-based calendar service provides calendar data access independent of the application program and device, and in a centrally-accessible location such as the Internet. The schema-based calendar service is extensible to handle extended contact information. While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer network, a method comprising,
providing a calendar schema, the calendar schema having calendar-related fields arranged into a content document with defined structures for the fields;
receiving a data access request directed to contact information, the request including associated identity information; and
in response to the data access request, manipulating at least one set of data in a logical calendar document that includes data therein according to the associated identity information, each set of data in the logical calendar document structured to correspond to a field in the content document.

2. The method of claim 1 wherein manipulating at least one set of data comprises reading data from at least one field in the logical calendar document.

3. The method of claim 1 wherein manipulating at least one set of data comprises writing data to at least one field in the logical calendar document.

4. In a computer network, a method comprising,
receiving a request to retrieve calendar data, the request including associated identity information;
reading from a data store to obtain calendar data based on the associated identity information;
constructing a calendar document including at least part of the data, the document arranged according to a defined schema for calendar data; and
returning the document in response to the request.

5. The method of claim 4 wherein the schema includes at least one defined field for extending the schema.
